(19) United States
(12) Patent Application Publication
(10) Pub. No.: US 2019/0062467 A1
(43) Pub. Date: Feb. 28, 2019

(54) POLYMERIZATION OF MICHAEL-TYPE MONOMERS

(71) Applicant: Technische Universität München, München (DE)

(72) Inventors: Maximilian Knaus, München (DE); Marco Giuman, München (DE); Bernhard Rieger, Elchingen (DE)

(21) Appl. No.: 16/087,225

(22) PCT Filed: Mar. 22, 2017
(86) PCT No.: PCT/EP2017/000359

§ 371 Date: Sep. 21, 2018

(30) Foreign Application Priority Data
Mar. 22, 2016 (EP) 16161796.4
Sep. 29, 2016 (EP) 16191393.4

(51) Int. Cl. C08F 4/52; B01J 31/22; C08F 220/44; C08F 220/54; C08F 226/06; C08F 222/10

(52) U.S. Cl. CPC C08F 4/52; B01J 31/2221; C08F 220/44; C08F 220/54; B01J 2231/12; C08F 222/10; B01J 2531/31; B01J 2531/023; C08F 226/06

(57) ABSTRACT

Catalyst and initiator compounds for precision polymerization of Michael-type monomers, precatalytic bridged complexes, such as those having formula R₁R₂M_{Z1}P_{Z2} or R₁R₂M_{z1}S_{z}, a system for precision polymerization, as well as processes for precision polymerization of Michael-type monomers, a process for preparing a bridged initiator and catalyst, a process for preparing a luminescent component, and polymers and components obtainable with the processes of the present invention are described.

### FIELD OF THE INVENTION

The present invention relates to a polymerization process, a system of catalysts and initiators for polymerizing Michael-type monomers, and polymers obtained with the method.

### BACKGROUND

The polymerization of Michael-type based monomers, for example acryl-based monomers, like methylacrylate, is well-known and common technology, such as radical polymerization, can be used. However, this common technology has its drawbacks and limitations. Radical initiated polymerizations are difficult to control with regard to tacticity and dispersity of polymers. Moreover, demanding monomers like acryl esters having bulky substituent groups, are difficult to polymerize and can be obtained only in low yields or with time and cost consuming processes. Tacticity and dispersity index are hardly or not to control for monomers like acrylonitrile. With the known methods such polymerization reactions could be controlled only by using catalysts comprising noble metals or rare earth metals which cause high cost and are detrimental for the environment.

Acryl-based polymers have been prepared in technical processes using free radical polymerization. Examples are the production of polymethacryl acid methyl ester (PMMA), or polyacrylonitrile (PAN). Those polymers are well-known and are used for example as fibers, in paints and dyes. The use of free radicals for polymerization, however, yields polymers with high polydispersity and the reaction is difficult to control. Many attempts have been made to find alternative processes to control the reaction of acrylic monomers. In one approach, acrylic polymers were made by using pure acrylonitrile in solution using the so-called RAFT-technology. This technique, however, does not allow to produce polyacrylonitrile with higher molecular weight but yields polymers with a molecular mass of about up to 16,000 g/mol and with a low molecular weight distribution of about 1.1 (see C. Tang et al., Macromolecules 2003, 36, 8587-8589).

On the other hand, it was possible to obtain polyacrylonitrile having high molecular weight (such as Mn>200,000 g/mol) with a lower polydispersity index (PDI 1.7-2.0) by using bis(thiobenzoyl)disulfide or bis(thiophenylacetoyl)disulfide. The use of activators for regeneration of RAFT-reagents allows to obtain polymers having a higher molecular weight, however, long reaction times are necessary, the yield is low and reagents for reduction which are expensive and partially toxic, like Sn-(2-ethylhexanoat) have to be applied.

Chen et al. (Y. Zhang et al., Angewandte Chemie 2010, 122, 10356-10360) used Lewis pairs for polymerization to overcome these disadvantages. It was assumed by Chen et al. that the polymerization occurs via a zwitter ionic intermediate structure, wherein the Lewis acid activates the monomer and the Lewis base binds to the activated monomer. Although some acrylic monomers could be polymerized with this technology, it was not possible to use this described process for polymerization of acrylonitrile or for sterically hindered acrylate esters. Thus, the Lewis pairs proposed by Chen et al. for polymerization could be used only for specific monomers, but not for sterically or electronically demanding monomers.

As outlined in Zhang et al. (Dalton transactions 2012, 41, 9119-9134, Synlett 2014, 25, 1534) it was not possible to convert furfurylmethacrylate. Another monomer, n-butylmethacrylate, could be reacted by using Lewis pair catalysis only with a yield of 35%.

Some Michael-type monomers could not or with low yield be polymerized with methods of the prior art, e.g. vinylphosphonates, vinylpyridines or vinylsulfonates. The polymerization and results thereof regarding molecular weight of the polymer, PDI of the polymer, yields, and/or turnover frequencies of the catalyst were insufficient.

The compound (dimethyl phosphinomethyl)dimethyl aluminum has been described by Karsch et al. (Organometallics, Vol 4., No. 2, 1985, 231-238) for use in synthetic chemistry. Moreover, it was known to use diethyl-[(4-methyl-pyridin-2-y)-methyl]aluminum or diethyl-(2-pyridinylmethyl)aluminum for hydrogenation of esters.

It was therefore an object of the present invention to provide catalytic compounds and processes for polymerizing Michael-type monomers, in particular advanced Michael-type monomers that until now were not available for regulated polymerization. It was a further object of the present invention to provide catalytic compounds and processes for polymerizing Michael-type monomers which allow to obtain polymers in a higher yield and/or with new properties. It was a further object of the present invention to provide catalytic compounds and processes for polymerizing Michael-type monomers with improved yield, PDI, turnover frequency and/or molecular weight.

It was a further object of the present invention to provide catalytic processes and catalysts which are environmentally friendly, less time consuming and more efficient than methods of the state of art.

### SUMMARY OF THE INVENTION

The problems are solved by the methods and the compounds and processes of the present invention.

The present invention provides catalyst compounds for catalysis and initiation as well as methods for polymerization of Michael-type monomers as defined in the claims. The new classes of catalysts and initiators allow polymerization of monomers that were not or difficult to polymerize until now. For example, the compounds of the present invention can be used for the polymerization of demanding Michael-type monomers having a substitution on the α-position or for the polymerization of acrylonitrile.

It was surprisingly found that compounds having a bridged Lewis acid/Lewis base system as defined below have high activity for activating Michael-type monomers, for starting polymerization and for maintaining a polymerization reaction. Furthermore the compounds allow the production of novel polymers with properties that were not available until now and can be used for polymerization of demanding monomers. With the catalyst and initiator compounds polymerization of demanding monomers is possible with short reaction time, resulting in polymers with controlled, pre-determined or regulated molecular mass with excellent yield. Polymers with high molecular mass can be obtained as well.

Furthermore it was found that a bridged Lewis acid/Lewis base complex as defined below can be further activated by reaction with a specific type of monomer and the adduct obtained as defined in detail below can be used for polymerization of Michael-type monomers having α-substituents such as methacryl based monomers.

Novel compounds active for polymerization of Michael-type monomers are precatalytic compounds having a formula R¹R²MZ¹PZ₂ or R¹R²MZ¹SZ, wherein the Lewis acid part R¹R²M and the Lewis base part, PZ₂ or SZ, respectively, are covalently linked via a bridge Z¹.

These compounds are useful for polymerization of Michael-type monomers having an α-acidic site, i.e. at least one hydrogen atom at the α-carbon atom of the Michael-type monomer. It is assumed that these compounds when contacted with a Michael-type monomer react with formation of an active adduct and elimination of the Lewis base part. Therefore, they are designated as “precatalytic”.

Compounds that surprisingly have been found to be active for catalysis and/or initiation of polymerization of demanding monomers even without an α-acidic site are described in the following. Some that have been found to be particular active are compounds of formulae I, II, and III.

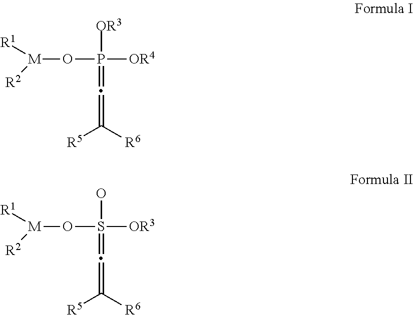

wherein M is Al, B, Ga, or In; each R¹ and R² is independently Cl, F, I, Br, or linear, branched or cyclic alkyl, heterocycloalkyl, linear, branched or cyclic alkenyl, heterocycloalkenyl, linear, branched, or cyclic alkinyl, heterocycloalkinyl, linear, branched, or cyclic alkoxy, aryl, heteroaryl, aryloxy, silyl, metallocenyl, nitro, nitroso, hydroxy, or carboxyl, wherein each alkyl, alkenyl, alkinyl or alkoxy group independently has up to 12 carbon atoms, wherein each aryl or heteroaryl independently has 5 to 10 ring atoms, wherein any hetero group has at least one hetero atom selected from O, S or N, wherein each alkyl, alkenyl, alkenyl or alkoxy, heterocycloalkyl, heterocycloalkenyl, heterocycloalkinyl, aryl, heteroaryl, aryloxy group can be substituted by 1 up to the highest possible number of halogen atoms; and wherein each R³ and R⁴ is independently linear or branched alkyl with a maximum carbon atom number of 4; and R⁵ and R⁶ are independently hydrogen or defined as R¹ and R². Preferably M is Al.

These compounds are suitable for providing higher turnover numbers higher molecular weights, lower PDIs and higher yields for the polymerization of Michael-type monomers, even for electronically and/or sterically demanding monomers. Compounds of formulae I and II in addition have the advantage that they are more environmental friendly and cheaper than rare earth metal or noble metal compounds.

Another class of compounds that have surprising properties are compounds of formula III which are active as catalyst and initiator compounds for the polymerization of Michael-type monomers, comprising a structure represented by the following formula:

[R⁹]ₙM-[Z³-Q]₃₋ₙ Formula III

wherein M is Al, Ga, or In;
wherein each R⁹ is independently Cl, F, I, or Br, linear, branched or cyclic alkyl, heterocycloalkyl, linear, branched or cyclic alkenyl, heterocycloalkenyl, linear, branched, or cyclic alkinyl, heterocycloalkinyl, linear, branched, or cyclic alkoxy, aryl, heteroaryl, aryloxy, silyl, metallocenyl, nitro, nitroso, hydroxy, or carboxyl, wherein each alkyl, alkenyl, alkinyl or alkoxy group independently has up to 12 carbon atoms, wherein each aryl or heteroaryl independently has 5 to 10 ring atoms, wherein any hetero group has at least one hetero atom selected from O, S or N, wherein each alkyl, alkenyl, alkenyl or alkoxy, heterocycloalkyl, heterocycloalkenyl, heterocycloalkinyl, aryl, heteroaryl, aryloxy group can be substituted by 1 up to the highest possible number of halogen atoms;
wherein Z³ is a single bond, —C(R¹⁰R¹¹)—, —S—, —O—, or —N(R¹²)—, wherein R¹⁰, R¹¹, R¹², independently are hydrogen or linear or branched C₁-C₅-alkyl;
wherein Q is an aromatic system comprising up to 3 aromatic rings, wherein the rings can independently be condensed or covalently linked, wherein the aromatic rings are independently 5- or 6-membered carbocyclic or heteroaromatic rings, at least one of which is a 5- or 6-membered heteroaromatic ring comprising at least one and up to 3 heteroatoms selected from N or S, wherein optionally Q has at least one unsubstituted carbon atom in a heteroaromatic ring in a position available for binding of an electrophilic substituent which is in vicinity to the heteroatom, wherein the system additionally can be substituted by one or more substituents selected from linear or branched C₁-C₅-alkyl, C₁-C₁-C₅-alkoxy, amino, nitro, nitroso, cyano, halogen, C₅-C₁₀ aryl, C₅-C₁₀ heteroaryl, or C₅-C₁₀ aryloxy;
wherein n is 1 or 2
with the proviso that the compound is not diethyl-[(4-methyl-pyridin-2-y)methyl]aluminum or diethyl-(2-pyridinylmethyl)aluminum.

Additionally, the invention provides a process for precision polymerization of Michael-type monomers using a bridged compound as catalyst, which comprises the steps:

a) contacting an α-acidic Michael-type monomer, optionally dissolved in an organic solvent, with a bridged precatalyst comprising a Lewis acid and a Lewis base, whereby a bridged initiator and catalyst is formed, and
b) continuing the reaction to form a polymer by reaction with at least one type of an α-acidic or non-α-acidic Michael-type monomer;
wherein the bridged precatalyst comprises a Lewis acid part [R¹R²M]⁺, and a Lewis base part [Z¹PZ₂]⁻ or [Z¹SZ]⁻, covalently linked via Z¹;
wherein in the Lewis acid part [R¹R²M]⁺ M is Al, Ga, or In; each R¹ and R² is independently Cl, F, I, Br or linear, branched or cyclic alkyl, heterocycloalkyl, linear, branched or cyclic alkenyl, heterocycloalkenyl, linear, branched, or cyclic alkinyl, heterocycloalkinyl, linear, branched, or cyclic alkoxy, aryl, heteroaryl, aryloxy, silyl, metallocenyl, nitro, nitroso, hydroxy, or carboxyl, wherein each alkyl, alkenyl, alkinyl, or alkoxy independently has up to 12 carbon atoms, wherein each aryl or heteroaryl independently has 5 to 10 ring atoms, wherein any hetero group has at least one hetero atom selected from O, S or N, wherein each alkyl, alkenyl, alkinyl or alkoxy, heterocycloalkyl, heterocycloalkenyl, heterocycloalkinyl, aryl, heteroaryl, aryloxy group can be substituted by 1 up to the highest possible number of halogen atoms and
wherein in the Lewis base part [Z¹PZ₂]⁻ or [Z¹SZ]⁻ each Z independently is a linear, branched, or cyclic alkyl, alkenyl, or alkinyl group, or heteroalkyl, heteroalkenyl, or heteroalkinyl, group, having up to 12 carbon atoms; or a donor substituted aryl or heteroaryl group having 5 to 10 ring atoms; wherein any hetero group comprises at least one hetero atom selected from O, S or N and
wherein Z¹⁻ is —C(R¹⁰R¹¹)—, —S—, —O—, or —N(R¹²)—, wherein R¹⁰, R¹¹, R¹², independently are hydrogen or linear or branched C₁-C₅-alkyl.

It is assumed that in this process when contacting an α-acidic Michael-type monomer, with a bridged precatalyst of the present invention at least one zwitterionic type complex is formed, whereby nucleophilic addition or deprotonation by the Lewis base part of the zwitterionic type complex forms an active complex which initiates the polymerization reaction with a Michael-type monomer and allows polymerization providing polymers with controlled molecular weights, higher yields and/or lower PDI compared to the prior art in a cheaper and environmental more friendly manner. The active complex not only provides for polymerisation of the same type of monomers, but can also be used as active catalyst for even more demanding monomers.

Surprisingly, it was also found that by using the process of the present invention and the catalyst activated by an α-acidic Michael-type monomer even Michael-type monomers having an α-substitution can be polymerized. This is possible when an activated bridged complex is used, which can be obtained by reacting the bridged complex as defined above with an α-acidic Michael-type monomer, such as one of the specific phosphor or sulfur containing monomers, resulting in an adduct as is described in more detail below. Thus, polymers and copolymers of α-acidic as well as non-α-acidic Michael-type monomers or any combination of both can be prepared with the methods and catalysts of the present invention.

The present invention also provides polymers which are obtained by the process of the present invention. Such polymers which are for example useful in the medical field (polyvinylphosphonates or polyvinylsulfonates) can be produced under controlled conditions and with less effort and under environmentally friendly conditions. Such polymers are characterized by having at least one olefinic terminal group which makes the polymers even more versatile because many different functions can easily be introduced via this olefinic group. For example, this olefinic terminal group can be used for functionalising a polymer by click chemistry or thiol-ene chemistry, it also provides a functional group for immobilisation or marking. Polymers with low and/or controlled PDI can be obtained as well as polymers with controlled tacticity. In Example 7 and FIG. 10 it is shown that syndiotactic polydimethyl methacrylamide can be prepared using a catalyst and initiator of the present invention.

Further aspects of the present invention are described below in detail.

### BRIEF DESCRIPTION OF THE DRAWINGS

FIG. 1a shows the GPC spectrum of the polymer obtained in example 1.

FIG. 1b NMR spectrum of the polymer obtained in example 1.

FIG. 2a shows the GPC spectrum of the polymer obtained in example 3.

FIG. 2b the NMR spectrum of the polymer obtained in example 3.

FIG. 3a shows the GPC spectrum the polymer obtained in example 4.

FIG. 3b shows the NMR spectrum of the polymer obtained in example 4.

FIG. 4a shows the GPC spectrum of the polymer obtained in example 5.

FIG. 4b shows the NMR spectrum of the polymer obtained in example 5.

FIG. 5 shows a UV/Vis spectrum (emission) of polymerized DEVP (PL maximum=435 nm) and a structural formula of the catalyst and initiator compound. Polymerization conditions: room temperature; monomer/catalyst ratio=100.

FIG. 6 shows a UV/Vis spectrum (emission) of polymerized 2-isopropenyl-2-oxazoline(PL maximum=510 nm) and a structural formula of the catalyst and initiator compound. Polymerization conditions: room temperature;

monomer/catalyst ratio=100.

FIG. 7 shows a UV/Vis spectrum (emission) of polymerized methyl methacrylate (PL maximum=480 nm) and a structural formula of the catalyst and initiator compound. Polymerization conditions: room temperature;

monomer/catalyst ratio=100.

FIG. 8 shows a UV/Vis spectrum (emission) of a luminescent compound (PL maximum=412 nm) produced out of 1 equivalent dimethyl(6-methylpyridin-2-yl)methyl)aluminum and phenylacetylen each.

FIG. 9 shows a UV/Vis spectrum (emission) of a luminescent compound (PL maximum=492 nm) produced out of 1 equivalent dimethyl(6-methylpyridin-2-yl)methyl)aluminum and 2-bromo-1,3,5-tris(trifluoromethyl)benzene each.

FIG. 10 shows a comparison of NMR spectra of atactic poly(dimethylacrylamide) and syndiotactically enriched poly(dimethylmethacrylate) produced by the inventive precatalyst (iBu)₂AlCH₂PMe₂.

FIG. 11 shows UV/Vis spectra (emission) of polymerized dimethylacrylamide (DMAA), diethylvinylphoshonate (DEVP) and diisopropylmethacrylamide (DiPMA).

FIG. 12 shows UV/Vis spectra (emission) of polymerized dimethylacrylamide (DMAA) using different catalysts P1 and L1.

FIG. 13 shows the solid-state structure of diethyl(2-pyridinylmethyl)aluminum from single X-ray analysis and structure of the Al(III)-based polymerization process of the present invention.

### DEFINITIONS

The term “α-acidic monomer” refers to a monomer having a hydrogen on the α-position of a Michael-type monomer. This proton can be cleaved off for example by a Bronsted base.

The terms “precatalyst or precatalytic compound” refer to a precursor of the inventive catalyst and initiator complex. The precatalyst, which includes a Lewis acid part covalently bound to a Lewis base part, can be reacted/contacted with a Michael-type monomer, whereby the inventive catalyst and initiator system is formed by deprotonation of the α-acidic hydrogen of the monomer.

The term “demanding Michael-type monomer” as used in this application refers to Michael-type monomers having a vinylogous system, which have electronically and/or sterically demanding properties, and which may not be polymerizable in good yields and/or high turnover frequencies and/or low PDIs by conventional catalysts. Examples for those demanding Michael-type monomers which can be polymerized with the catalyst/initiator systems and methods of the present invention are vinyl phosphonates vinyl sulfonates, vinyl pyridines, substituted or unsubstituted acrylamides, substituted or unsubstituted acrylates and methacrylates, like butyl acrylate, isobutyl acrylate, tert.-butyl acrylate, isobornyl acrylate, furfuryl acrylate, glydidyl acrylate, acrylonitrile, vinyl ketones, like vinyl methyl ketone, acrolein and acrolein derivates among others. Monomers like α-methylene-γ-butyrolactone (MBL) and γ-methyl-α-methylene-γ-butyrolactone (γ-MMBL) are not deemed to be demanding Michael-type monomers.

The term “precision polymerization” relates to polymerization of Michael-type monomers by using the catalyst and initiator system of the present invention. This allows polymerization of monomers which are difficult or not (i.e. in a non-controllable manner) to polymerize by conventional anionic polymerization methods or radical polymerization methods. Furthermore this term relates to polymerization processes with a sufficient TOF i.e. short reaction time, which provide polymers with low polydispersity index, high yields, and with controllable molecular weight and tacticity.

“Bridged complex” when used in the present application refers to a complex wherein a Lewis acid part and a Lewis base part are covalently connected by a bridge, such as a methylene bridge. The bridged complex is also referred to as “precatalytic” compound or complex as this complex can be activated as catalyst by reaction with at least one Michael-type monomer.

The term “catalyst and initiator complex” refers to compounds of the present invention which include a part (derived from the Lewis acid part of the bridged complex) which is deemed to be catalytically active for polymerization and a part (derived from the specific monomer) which is deemed to be an initiator for polymerization in one molecule and is obtainable by contacting/reacting a bridged compound with a specific type of a Michael monomer, i.e. a vinyl phosphonate or vinyl sulfonate. Without being bound by theory it is assumed that for polymerization, the catalyst and the initiator part can dissociate; the initiator part starts the chain propagation while the catalysts catalyzes the mentioned reaction. Such compounds can include electrophilic site and a nucleophilic side which are connected by a covalent bridge. The electrophilic site is a Lewis acid and the nucleophilic site is a Lewis base which is covalently linked by a bridge. This molecular bridge can for example be a methylene bridge.

Groups like alkyl, alkenyl, alkinyl, or alkoxy, heterocycloalkyl, heterocycloalkenyl, heterocycloalkinyl, aryl, heteroaryl, can be substituted or unsubstituted and substituents can be present up to the highest possible number, as long as the compounds retain the necessary properties.

The term “substituted” when used in connection with groups like alkyl, alkenyl, alkinyl, or alkoxy, heterocycloalkyl, heterocycloalkenyl, heterocycloalkinyl, aryl, heteroaryl, or acrylate or methacrylate indicates that such a group is substituted by at least one substituent and up to the highest possible number of substituents, where the substituents are selected from linear, branched, or cyclic alkyl, alkenyl, alkinyl groups having up to 6 carbon atoms, linear, branched, or cyclic alkoxy groups having up to 6 carbon atoms, metallocenyl, nitro, nitroso, hydroxy, carboxyl, or aryl, such as phenyl or naphthyl, or heteroaryl.

The term “substituted by halogen” when used in connection with carbon containing groups refers to partially or fully halogenated, such as perfluorinated groups. The term “wherein each alkyl, alkenyl, alkinyl, or alkoxy, heterocycloalkyl, heterocycloalkenyl, heterocycloalkinyl, aryl, heteroaryl, aryloxy group can be substituted by 1 up to the highest possible number of halogen atoms” refers to such groups that can carry only one halogen, in particular chlorine, fluorine or bromine, or more halogen atoms. Any possible number of halogen atoms can be present on a group and the “highest possible number of halogen atoms” refers to groups wherein each hydrogen has been replaced by a halogen atom, in other words that are perhalogenated.

The term “donor substituted” refers to substituents that can add to an electronic π system such as R, OR, SR, NR₂, wherein R is linear or branched alkyl, such as methyl, ethyl, isopropyl, isobutyl, butyl, tert.-butyl, aryl, or heteroaryl as defined above.

The term “electrophilic substrate” refers to a compound, an element or a unit that contributes an electrophilic site. Such an electrophilic site is characterized by a lower electron density than the electron density of at least one adjacent atom or an adjacent functional group. This difference in electron density can in general be generated by two different reasons. The first one is a significant difference in electronegativity. This difference can be easily evaluated by the skilled person by comparing the Pauling electronegativity values. For providing an electrophilic site the electronegativity of an atom has to be significantly lower than the electronegativity of at least one adjacent atom or the mean electron negativity of an adjacent functional group. In this context a significant difference in electronegativity means >0.3, preferable >0.6, more preferable >0.8 and most preferable >1.

Examples for such electrophilic sites are the carbon atoms of a carbonyl group, CO₂, CO, carbonic acids and their derivatives, epoxides, halogenated aromatics, perhalogenated aromatics, alkyl, alkenyl and alkenyl compounds with highly σ-electron accepting groups such as nitro, nitroso, nitroxy, carboxy, carbonyl, halogens, sulfonyl, cyanide.

Another possibility to provide an electrophilic site in conjugation of a double or triple bond with a π-accepting group. The carbon in β-position can act as an electrophilic site, due to the possibility of creating a tautomeric form, as shown by the following scheme.

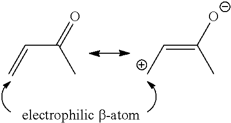

Typical examples are the β-carbon atoms of α, β-unsaturated compounds, e.g. a

Michael-monomer, enones or α, β-unsaturated aldehydes.

The term “luminescent” when used in the present description refers to a property of a compound to emit visibile light after energetic excitation. The energetic excitation can be via UV light, electronically, chemically or by other energetic sources known to the person skilled in the art. Luminescence comprises emission of light in all visible colors. The term “luminescence” includes fluorescence, phosphorescence or other mechanisms of visible light emission.

A “luminescent component” is a molecule that has luminescence or can be induced to be luminescent. A luminescent component can be an adduct of a metal compound of the present invention and a monomer, where the luminescent part can be contributed by a ligand of the metal compound or by a monomer, or it can be an oligomer or polymer with a luminescent unit, which has been obtained by using the metal compound and the monomer component of the present invention.

The terms “luminescent unit”, “luminescent element” and “luminescent group” are used interchangeable and refer to groups that contribute to luminescence in a molecule. All of those can be part of the luminescent component.

The term “in vicinity” when used in connection with an unsubstituted carbon atom in a heteroaromatic ring refers to a carbon atom that is in electronically relevant position with regard to a hetero atom of the heteroaromatic ring to allow reaction with an electrophilic compound that contributes conjugated π electrons.

### DESCRIPTION OF THE INVENTION

The present invention is concerned with novel compounds that are active as catalyst for polymerization of Michael-type monomers. Provided is a precatalytic bridged complex having formula R¹R²M PZ₂ or R¹R²MZ¹SZ, wherein a Lewis acid part R¹R²M and a Lewis base part, PZ₂ or SZ, are covalently linked via a bridge Z¹, wherein M is Al, Ga, or In; each R¹ and R² is independently Cl, F, I, Br or linear, branched or cyclic alkyl, heterocycloalkyl, linear, branched or cyclic alkenyl, heterocycloalkenyl, linear, branched, or cyclic alkinyl, heterocycloalkinyl, linear, branched, or cyclic alkoxy, aryl, heteroaryl, aryloxy, silyl, metallocenyl, nitro, nitroso, hydroxy, or carboxyl, wherein each alkyl, alkenyl, alkinyl, or alkoxy group independently has up to 12 carbon atoms, wherein each aryl or heteroaryl independently has 5 to 10 ring atoms, wherein any hetero group has at least one hetero atom selected from O, S or N, wherein each alkyl, alkenyl, alkenyl or alkoxy, heterocycloalkyl, heterocycloalkenyl, heterocycloalkinyl, aryl, heteroaryl, aryloxy group can be substituted by 1 up to the highest possible number of halogen atoms, and

wherein each Z independently is a linear, branched, or cyclic alkyl, alkenyl, or alkinyl group, or heteroalkyl, heteroalkenyl, or heteroalkinyl, group, having up to 12 carbon atoms; or a donor substituted aryl or heteroaryl group having 5 to 10 ring atoms, wherein any hetero group comprises at least one hetero atom selected, from O, S or N and wherein Z¹⁻ is —C(R¹⁰R¹¹)—, —S—, —O—. —N(R¹²)—, wherein R¹⁰, R¹¹, R¹², independently are hydrogen or linear or branched C₁-C₅-alkyl;

with the proviso that the compound is not (dimethyl phosphinomethyl)dimethyl aluminum. Preferably, M is Al.

The precatalytic compound has two substituents Z at the phosphor or sulfur atom, respectively, which can be the same or different. Commonly, those compounds having two identical Z groups are used for the sake of convenience, but compounds with an asymmetric phosphane or sulfane part can be used as well. In some cases different groups can be used to adapt properties.

These compounds as well as (dimethyl phosphinomethyl)dimethyl aluminum are valuable as catalysts. It has been found that a complex that is built by bridging a Lewis acid part as defined with a Lewis base part as defined has activity in catalyzing polymerization for Michael-type monomers, as long as the monomers have at least one α-acidic hydrogen atom. These compounds can catalyze the polymerization of Michael-type monomers like dimethyl vinyl phosponate (DMVP), diethylvinyl phosphonate (DEVP), di-, isopropylvinyl phosphonate (DIVP), 4-vinylpyridine, and acrylonitrile, among others.

Examples for catalyst and initiator compounds of the present invention that are useful in the polymerization of Michael-type monomers, are represented by the following formulae:

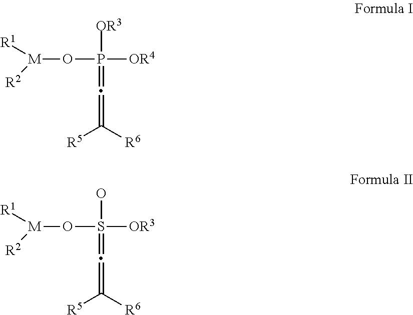

wherein M is Al, B, Ga, or In, preferably Al; each R¹ and R² is independently Cl, F, I, Br, or linear, branched or cyclic alkyl, heterocycloalkyl, linear, branched or cyclic alkenyl, heterocycloalkenyl, linear, branched, or cyclic alkinyl, heterocycloalkinyl, linear, branched, or cyclic alkoxy, aryl, heteroaryl, aryloxy, silyl, metallocenyl, nitro, nitroso, hydroxy, or carboxyl, wherein each alkyl, alkenyl, alkinyl, or alkoxy group independently has up to 12 carbon atoms, wherein each aryl or heteroaryl independently is 5 to 10 ring atoms, wherein any hetero group has at least one hetero atom selected from O, S or N, wherein each alkyl, alkenyl, alkinyl or alkoxy, heterocycloalkyl, heterocycloalkenyl, heterocycloalkinyl, aryl, heteroaryl, aryloxy group can be substituted by 1 up to the highest possible number of halogen atoms; and wherein each R³ and R⁴ is independently linear or branched alkyl with a maximum carbon atom number of 4; and R⁵ and R⁶ are independently hydrogen or defined as R¹ and R².

These compounds are built from a bridged Lewis acid/Lewis base complex and an α-acidic Michael-type monomer, in particular a vinyl sulfonate or vinyl phosphonate based monomer. It seems that this specific complex provides active sites and activation energy such that very difficult to polymerize monomers can be activated, such as vinyl sulfonates or vinyl phosphonates, vinyl pyridines or vinyl based monomers with substitution at the a site. Surprisingly, it has been found that these adducts, such as compounds of formulae I or II are active not only for the polymerization of α-acidic Michael-type monomers, but also for polymerization of non-α-acidic Michael-type monomers. In other words a precatalytic compound can be activated by contacting it with an α-acidic Michael-type monomer whereby an adduct is formed, By using such an adduct, monomers like methyl methacrylate, ethylmethacrylate, butyl methacrylate, tert.-butyl methacrylate, or furfurylmethacrylate, among others, can be polymerized.

Therefore, in another aspect of the present invention a process for preparing an initiator and catalyst adduct, such as shown in formula I or II, is provided which comprises contacting an α-acidic Michael-type monomer, optionally dissolved in an organic solvent, with a precatalyst, having formula R¹R²MZ¹PZ₂ or R¹R²MZ¹SZ in a molar ratio of precatalyst to monomer of 1:1 to 2:1, whereby a bridged initiator and catalyst is formed, wherein R¹, R², M, Z¹, Z are as defined above, wherein optionally the α-acidic Michael-type monomer is selected from phosphonates, in particular diethylvinylphosphonate, or diisopropylvinylphosphonate, sulfonates, acrylates, acrylonitrile, or vinylpyridines.

Without being bound by theory it is assumed that a direct initiation is created by the complex of the present invention which has kinetic advantages. The first species which is shown in scheme 1 provides kinetic advantages which are likely to result from a concerted activation pathway between monomer, initiator and catalyst. Due to the cooperative interactions of Lewis acid and Lewis base parts, the polymerization is also thermodynamically favored, since the loss of entropy for building the active species is reduced in comparison to a frustrated Lewis acid-monomer-Lewis base system. The initiating part, which for example can be an allenyl-phosphonate or -sulfonate (Lewis Base), nucleophilicly attacks the δ⁺ site of the advanced Michael-type monomer (in Scheme 1B: diethylvinylphosphonate (DEVP)) which is weakly coordinated to the metal center. The metal center (Lewis acid) catalyzes the chain propagation by a group transfer polymerization. Additionally, the pathway using bridged catalysts of the present invention yields polymers with olefinic end groups.

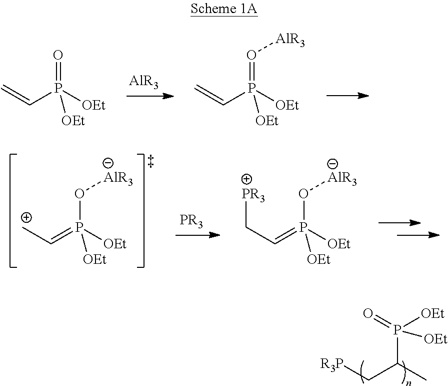

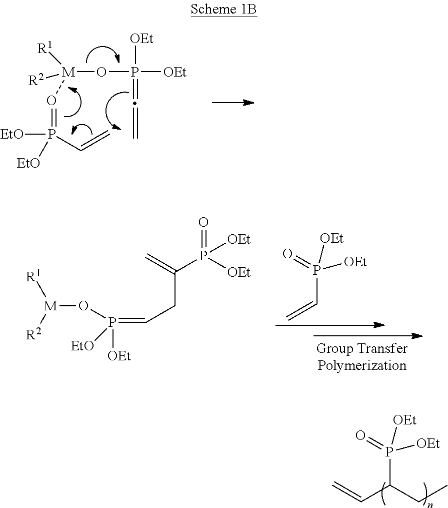

The metal M of compounds of Formulae I and II can be AI, B, Ga or In, preferably Al. It is very important that the metal has Lewis acidic properties. For the polymerization mechanism of the present invention, metals which have three valences in a bridged structure together with an initiator compound, which is the Lewis base, can be used, preferably Al, Ga or In. Thus, the Lewis acid has a free coordination site because of an electron sextet. It is assumed, without being bound by theory, that after being cleaved off from the initiating compound (allenylphosphonate or allenylsulfonate), Lewis acidity even increases since an electron quartet is formed around the metal which also increases the catalytic activity and therefore the turnover numbers. Therefore, chain propagation reaction can yield high molecular weight polymers in short time.

The residues R¹ and R² of the catalytic and initiating compound have an influence on the acidity and residues can be selected in each case for adjusting the Lewis acid strength of the metal center. This means, if R¹ and/or R² are electron withdrawing groups (EWG), the Lewis acidity is increased, vice versa the Lewis acidity is decreased if R¹ and/or R² are electron donating groups. Therefore, the Lewis acidity can be adjusted accordingly to the chemical polymerization requirements of a specific type of Michael-type monomer used. However, it is very important that the Lewis acidity is not too high i.e. the binding of the Lewis acid or catalyst site to the initiator or Lewis base should not be too strong. Vice versa, binding should not be too weak which would cause a dissociation before the nucleophilic attack of the initiating part can take place. In one embodiment R¹ and R² are alkyl, aryl, fluorinated alkyl or aryl, or cycloalkyl, such as methyl, ethyl, propyl, isopropyl, butyl, ilsobutyl, tert.-butyl, neopentyl, octyl, phenyl, cyclopentadienyl, tetramethyl-cyclopentadienyl, pentamethyl-cyclopentadienyl, CF₃, CF₂CF₃, C₆F₅.

Furthermore, R¹ and R² can have an influence on the steric interaction between the catalyst and initiator compound and the monomer which can also control tacticity It has been found that syndiotacticity can be increased by increasing the size of substituents of the metal, i.e. of R¹ and R². When (iBu)₂AlCH₂PMe₂ is used as catalyst for polymerizing dimethyl acrylamide syndiotacticity of the polymer obtained can be in the range of up to more than 80%, whereas when using Me₂AlCH₂PMe₂ an atactic polymer is obtained. The substituents of the monomer can have a similar influence.

Substituents R³ and R⁴ are not as critical as the aluminum substituents. In one embodiment R³ and R⁴ are alkyl, aryl, fluorinated alkyl or aryl, or cycloalkyl, such as methyl, ethyl, propyl, isopropyl, butyl, ilsobutyl, tert.-butyl, neopentyl, octyl, phenyl, cyclopentadienyl, tetramethyl-cyclopentadienyl, pentamethyl-cyclopentadienyl, CF₃, CF₂CF₃, C₆F₅.

In addition, substituents R⁵ and R⁶ can have an influence on the nucleophilicity i.e. Lewis basicity of the allenylphoshonate or allenylsulfonate group. Therefore, nucleophilicity can be adjusted if necessary.

Catalytic and initiating compounds of formulae I and II of the present invention can be generated in situ or ex situ. In one embodiment, the inventive compounds are generated in situ by using a precatalytic compound containing a Lewis acidic and Lewis basic center as described above, like for example Me₂AlCH₂PMe₂. Without being bound by theory, it seems that the deprotonation of an α-acidic Michael-type monomer, such as an α-acidic vinylphosphonate or an α-acidic vinylsulfonate by the bridging group yields allenyl compounds of formulae I and II. In another embodiment, the catalyst structure could also be produced or generated ex situ by deprotonation and addition of an α-acidic Michael-type monomer, such as a vinylsulfonate or vinylphosphonate, in equimolar amounts and provided for the reaction when needed.

Preferred embodiments of the inventive bridged catalyst and initiator compounds are:

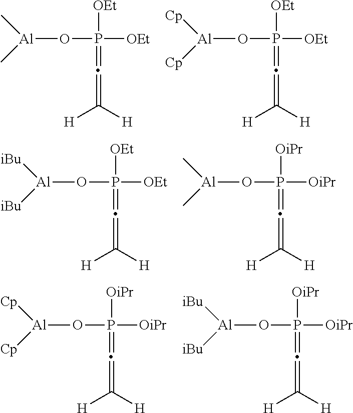

In one embodiment, a bridged catalyst and initiator compound according to formulae I or II can be used for the same Michael-type monomer which is converted into the initiating

Lewis Base for the following polymerization. In a further embodiment a catalyst and initiator compound of the present invention can also be used for polymerization of other Michael-type monomers or mixtures thereof. Thus, Michael-type monomers with a substitution on the α-position or without can be polymerized using the bridged catalyst and initiator compound according to the present invention. It is possible to polymerize only one type of Michael monomer or a combination of two or more Michael-type monomers. For example, the Michael-type mononer used in the first step can be different from the monomer used in the second step, and/or in step a) and/or in step b) combinations of two or more types of mononers can be used.

The present invention also provides a process for precision polymerization of Michael-type monomers which comprises:

a) contacting an α-acidic Michael-type monomer, optionally dissolved in an organic solvent, with a bridged precatalyst system comprising a Lewis acid and a Lewis base, whereby a bridged initiator and catalyst is formed, and
b) continuing the reaction to form a polymer by reaction with at least one type of an α-acidic or non-α-acidic Michael-type monomer;
wherein the bridged precatalyst comprises a Lewis acid part [R¹R²M]⁺, and a Lewis base part [Z¹PZ₂]⁻ or [Z¹SZ]⁻, covalently linked via Z¹;
wherein in the Lewis acid part [R¹R²M]⁺ M is Al, Ga, or In; each R¹ and R² is independently Cl, F, I, Br or linear, branched or cyclic alkyl, heterocycloalkyl, linear, branched or cyclic alkenyl, heterocycloalkenyl, linear, branched, or cyclic alkinyl, heterocycloalkinyl, linear, branched, or cyclic alkoxy, aryl, heteroaryl, aryloxy, silyl, metallocenyl, nitro, nitroso, hydroxy, or carboxyl, wherein each alkyl, alkenyl, alkinyl, or alkoxy independently has up to 12 carbon atoms, wherein each aryl or heteroaryl independently has 5 to 10 ring atoms, wherein any hetero group has at least one hetero atom selected from O, S or N, wherein each alkyl, alkenyl, alkinyl or alkoxy, heterocycloalkyl, heterocycloalkenyl, heterocycloalkinyl, aryl, heteroaryl, aryloxy group can be substituted by 1 up to the highest possible number of halogen atoms and
wherein in the Lewis base part [Z¹PZ₂]⁻ or [Z¹SZ]⁻ each Z independently is a linear, branched, or cyclic alkyl, alkenyl, or alkinyl group, or heteroalkyl, heteroalkenyl, or heteroalkinyl, group, having up to 12 carbon atoms; or a donor substituted aryl or heteroaryl group having 5 to 10 ring atoms; wherein any hetero group comprises at least one hetero atom selected from O, S or N and
wherein Z¹⁻ is —C(R10R¹¹)—, —S—, —O—, or —N(R¹²)—, wherein R¹⁰, R¹¹, R¹² independently are hydrogen or linear or branched C₁-C₅-alkyl. In one embodiment the heteroaryl group of Z is not quinolinyl or picolinyl. In a preferred embodiment the heteroaryl group of Z is a 5- or 6-membered ring comprising at least one hetero atom selected from O, S, or N.

This process provides polymers having favourable properties, for example with regard to polymer mass, yield and/or tacticity, as well as polydispersity of the produced polymers, and in particular allows to control the process. It is assumed, without being bound by theory, that when contacting an α-acidic advanced Michael-type monomer, optionally dissolved in an organic solvent, with a bridged precatalytic compound as defined above, at least one zwitterionic type complex is formed, and by nucleophilic addition or deprotonation by the Lewis base part an active complex is formed which initiates the polymerization reaction.

The polymerization process of Michael-type monomers of the present invention allows conversions yielding products with controlled molecular weights, in higher yields and with lower PDI. Additionally it is possible to control or adapt tacticity.

The process of the present invention enables a cheap and environmental friendly polymerization with main group elements of advanced Michael-type monomers.

In a preferred embodiment, the process can be carried out under protection gas which can be selected from nitrogen, helium, argon, xenon and other protection gases known to the person skilled in the art.

In step a) of the process of the present invention a Michael-type monomer is contacted with a bridge precatalyst as defined above and represented by one of formulae R¹R²MZ¹PZ₂ or R¹R²MZ¹SZ. R¹, R², M, Z, Z¹, and Z₂ are as defined above, wherein M aluminum, gallium or indium, and is preferably Al. Without being bound to a theory it is assumed that after abstraction of the α-acidic proton of the Michael-type monomer by the base part [Z¹PZ₂]⁻ or [Z¹SZ]⁻ of the precatalyst, a Lewis base/Lewis acid comprising catalyst and initiator compound is formed as discussed above. The nucleophilic allene part (Lewis base) is the initiator for the following polymerization which is continued by the addition of further monomer in step b), where the monomer can be any Michael-type monomer, i.e. can be α-acidic or not. This allows the polymerization of sterically and otherwise demanding monomers with the system of the present invention. In particular it allows to polymerize monomers like methacrylates and methacrylamides, among others. The abstraction of the hydrogen in step a) takes place via the basic Z¹⁻ ligand which is covalently bridging the metal Lewis acid site with the phosphor or sulfur center. Those compounds are precatalysts which form an active bridged catalyst and initiator species as illustrated for example for DEVP in Scheme 2. Scheme 2 is also applicable to other Michael-type monomers for steps a) and b).

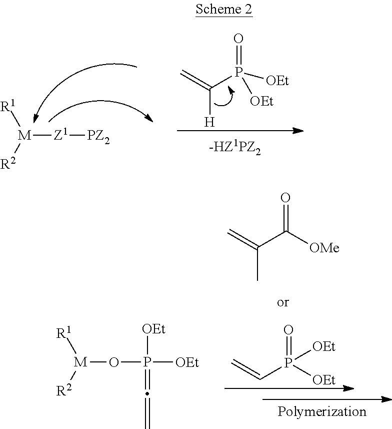

The Michael-type monomer of step a) of the inventive process can be the same or different to the monomer of step b).

When the first monomer of the inventive process is a vinyl pyridine, the bridged catalyst and initiator compound is formed after deprotonation of the vinyl pyridine. Hereby, the Lewis acid adds to the N-functionality of the pyridine and the Lewis Base allenylpyridinium is the nucleophilic initiator for the following polymerization.

In one embodiment, for the whole process the same monomer is used, which has an α-acidic hydrogen that is deprotonated in step a) and which is used for polymerization in step b). The monomers used in steps a) and b) can be different, so that the activation by abstracting the hydrogen in step a) is done by a different monomer than the monomer that is polymerized in step b). It is also possible to use the monomer type used in step a) also in step b) together with one or more types of monomers, as long as the monomers are Michael-type monomers. This for example allows to polymerize Michael-type monomers with a substitution at α-position in step b) or to polymerize copolymers.

The process of the invention allows high polymeric yields such as at least 80% conversion of the Michael-type monomers, or even between 90 and 100% or about 100%.

The process of the present invention allows to also control polydispersity and to obtain polymers having a low to very low polydispersity index.

The use of the catalytic and intiatiator compounds of the present invention provides for kinetic advantages and results in higher turnover frequencies of 50 to 10000 or even more, such as 100 to 2000, for example of 500 to 1800. Furthermore, it was found that catalyst activity, polymer yield, molecular mass of the final polymer and polydispersity index are dependent from the molar ratio of monomer to catalyst system, in other words the catalyst loading. It was found, that a high catalyst loading, i.e. a molar ratio of monomer/catalyst of less than 1000 results in a high yield, nearly stoichiometric monomer consumption and a low molecular mass. Thus, the molar ratio of monomer/catalyst system can for example be in a range of 100 to 15000, such as 200 to 10000.

Thus, by using the catalyst system of the present invention, it is possible depending on the desired final product to adapt the catalyst system. According to one embodiment of the present invention, where polymers having a lower molecular mass are required, a high catalyst loading is applied. One advantage of the catalyst and initiator system of the present invention is the possibility to regulate the molecular mass of the polymer obtained. Thus, it is possible to produce polymers with high molecular mass of 200,000 g/mol and above, or to produce polymers with a medium or low molecular mass, depending from the end use of the polymer. For some uses a lower molecular mass is useful, for example for adhesives or lubricants, whereas for the use as fibers high molecular mass if of interest. All these types of polymers can be produced with the catalyst system and the methods of the present invention. For example, a molecular mass of 5,000 or below and up to 200,000 and beyond can be obtained.

As outlined above many types of monomers can be polymerized with the system and the method of the present invention. Examples of demanding Michael-type monomers that can be polymerized in high yield, with high TOF and with interesting properties are vinylphosphonates, in particular diethylvinylphosphonate, or diisopropylvinylphosphonate; vinylsulfonates, substituted or unsubstituted acrylates and methacrylates, such as butyl acrylate, isobutyl acrylate, tert.-butyl acrylate, isobornyl acrylate, furfuryl acrylate, glydidyl acrylate, hexylacralate, methylmethacrylate; substituted or unsubstituted acrylamides, such as methacrylamide, dimethylacrylamide, di-isopropylacrylamide; acrylonitrile, vinylpyridines; vinyl ketones, such as vinylmethylketone; acrolein and acrolein derivates.

The process of the present invention can be carried out in a broad temperature range. Polymerization reactions can be conducted with Michael-type monomers in a range of −115° C. to 150° C. In most cases, the process of the present invention can be carried out at room temperature, which is advantageous as no heating or cooling is necessary. Activity of the catalyst and initiator compound can be increased, by lowering the temperature to 0° C. or below and very favourable results can be obtained. High conversion rates are obtained between about 0° C. and room temperature, i.e. 25° C.

Thus, although the process can be used in a broad temperature range, in a preferred embodiment, the process is carried out at a temperature between −10° C. and 25° C., preferably between 0 and 25° C. The optimum temperature for a specific process can be found in routine tests depending on the catalyst and initiator compound, monomer and solvent used.

The process of the present invention can be carried out in the presence of an organic solvent. The term “organic solvent” as used in the present application refers to a compound that is liquid at room temperature and/or process temperature. Organic solvents are very well-known in the art. An organic solvent in the process of the present invention can have different functions: it can be used as inert carrier that not necessarily dissolves any of the three components; it can be used to dissolve the monomer; it can be used as heat dissipating agent. Furthermore, the polarity of the solvent can have an influence on the tacticity. Thus, in cases where tacticity is an issue the polarity of the solvent has to be considered and a suitable solvent has to be selected.

The reaction usually is carried out in a fluid medium which can be an organic solvent which dissolves the monomer, in a salt melt, or a gas. Organic solvents that are usable for the preparation of polymers from acryl-based monomers are known and those that are used in the prior art can be used for the process of the present invention, too. Usually aromatic or aliphatic hydrocarbons, heteroaromatic and heteroaliphatic compounds, as long as they are liquid at process temperature, or ionic solvents are suitable. Also salt melts as well as supercritical CO₂ can be used. Aromatic hydrocarbons that are very common in this field are preferred, such as toluene which is particularly useful.

The amount of solvent is that which is usually used. By increasing or decreasing the amount of solvent, the activity and the duration can be influenced as it is well-known to the skilled person.

Examples for bridged precatalysts of the present invention are Me₂Al—CH₂—PMe₂, Me₂Al—CH₂—P(t-Bu)₂, i-Bu₂Al—CH₂—P(t-Bu)₂ or Me₂Al—CH₂—P(i-Pr)₂ as shown in the following formulae.

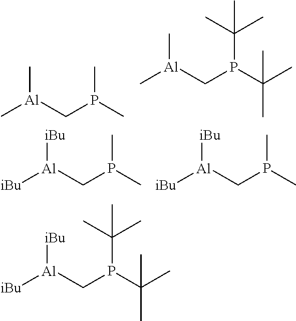

In one embodiment, in the process of the present invention Michael-type monomer diethylvinylphosphonate is used in steps a) and b) and Me₂Al—CH₂—PMe₂ is used as precatalyst

In a further embodiment, in the process according to the present invention Michael-type monomer 4-vinylpyridine is used in steps a) and b) and Me₂Al—CH₂—P(t-Bu)₂ is used as precatalyst. Both embodiments yield very favourable polymers having valuable properties.

The method of the present invention also allows to polymerize acrylonitrile, a monomer that until now could be polymerized only by non controllable methods. Thus, it is possible to obtain a poly-acrylonitrile having a high molecular weight such as 100,000 g/mol or more, and a low dispersity. Such a polyacrylonitrile was not available with the methods known in the prior art.

The present invention also relates to polymers which are obtainable by catalyst and initiator systems and by the processes of the present invention. As already indicated in Scheme 1 b, polymers which are obtained according to the present invention are characterized by having an olefinic end group. Such a terminal group allows functionalisation and chemical variation. Thus, the polymers can be functionalised in many different ways so that a versatile product is provided. The terminal group can be used for coupling other molecules like other polymers to form blockcopolymers. Furthermore, functional groups can be easily introduced by using click chemistry or thiol-ene chemistry. Furthermore, reactions with transition metal catalysts allow copolymerisation with olefinically unsaturated monomers like ethene or propene.

The present invention allows to obtain polymers, wherein the polymer is a polymer or copolymer of one or more of Michael monomers selected from the group consisting of vinylphosphonate, in particular diethylvinylphosphonate, or diisopropylvinylphosphonate; vinylsulfonate, substituted or unsubstituted acrylate and methacrylate, such as butyl acrylate, isobutyl acrylate, tert.-butyl acrylate, isobornyl acrylate, furfuryl acrylate, glydidyl acrylate; substituted or unsubstituted acrylamide, such as methacrylamide, dimethylacrylamide, acrylonitrile, vinylpyridine, vinyl ketone, acrolein or an acrolein derivate.

A further aspect of the present invention is a system for precision polymerization, comprising

a) an α-acidic Michael-type monomer,

b) a precatalyst having formula R¹R²MZ¹PZ₂ or R¹R²MZ¹SZ comprising a Lewis acid part [R¹R²M]⁺, as catalyst, and a Lewis base part [Z¹PZ₂]⁻ or [Z¹SZ]⁻ covalently combined in one molecule,

c) optionally an organic solvent,

wherein components a) and b) can form an active initiator and catalyst complex,
wherein a Lewis acid part R¹R²M and a Lewis base part, PZ₂ or SZ, are covalently linked via a bridge Z¹, wherein M is Al, Ga, or In; each R¹ and R² is independently Cl, F, I, Br or linear, branched or cyclic alkyl, heterocycloalkyl, linear, branched or cyclic alkenyl, heterocycloalkenyl, linear, branched, or cyclic alkinyl, heterocycloalkinyl, linear, branched, or cyclic alkoxy, aryl, heteroaryl, aryloxy, silyl, metallocenyl, nitro, nitroso, hydroxy, or carboxyl, wherein each alkyl, alkenyl, alkinyl, or alkoxygroup independently has up to 12 carbon atoms, wherein each aryl or heteraryl independently has 5 to 10 ring atoms, wherein any hetero group has at least one hetero atom selected from O, S or N, wherein each alkyl, alkenyl, alkenyl or alkoxy, heterocycloalkyl, heterocycloalkenyl, heterocycloalkinyl, aryl, heteroaryl, aryloxy group can be substituted by 1 up to the highest possible number of halogen atoms and wherein each Z independently is a linear, branched, or cyclic alkyl, alkenyl, or alkinyl group, or heteroalkyl, heteroalkenyl, or heteroalkinyl, group, having up to 12 carbon atoms; or a donor substituted aryl or heteroaryl group having 5 to 10 ring atoms, wherein any hetero group comprises at least one hetero atom selected from O, S or N and wherein Z¹⁻ is —C(R¹⁰R¹¹)—, —S—, —O—, or —N(R¹²)—, wherein R¹⁰, R¹¹, R¹², independently are hydrogen or linear or branched C₁-C₅-alkyl.

In one embodiment, a catalyst system for the precision polymerization comprises 4-vinyl pyridine as a monomer and a precatalyst Me₂Al—CH₂—(t-Bu)₂ or diethylvinylphosphonate as monomer and a precatalyst Me₂Al—CH₂—PMe₂.

Furthermore, the inventors of the present invention surprisingly found, that nitrogen containing heterocyclic compounds have excellent properties for catalysis and activation in precision polymerization processes of Michael-type monomers. Furthermore, it was found that using such compounds can result in compounds and/or polymers having luminescent activity.

Thus, the present invention is also concerned with a catalyst and initiator compound for the polymerization of Michael-type monomers, comprising a structure represented by the following formula III:

[R⁹]ₙM-[Z³-Q]₃₋ₙ

wherein M is Al, Ga, or In;

wherein each R⁹ is independently Cl, F, I, or Br, linear, branched or cyclic alkyl, heterocycloalkyl, linear, branched or cyclic alkenyl, heterocycloalkenyl, linear, branched, or cyclic alkinyl, heterocycloalkinyl, linear, branched, or cyclic alkoxy, aryl, heteroaryl, aryloxy, silyl, metallocenyl, nitro, nitroso, hydroxy, or carboxyl, wherein each alkyl, alkenyl, alkinyl, or alkoxy independently has up to 12 carbon atoms, wherein each aryl or heteroaryl independently has 5 to 10 ring atoms, wherein any hetero group has at least one hetero atom selected from O, S or N, wherein each alkyl, alkenyl, alkinyl or alkoxy, heterocycloalkyl, heterocycloalkenyl, heterocycloalkinyl, aryl, heteroaryl, aryloxy group can be substituted by 1 up to the highest possible number of halogen atoms;

wherein Z³ is a single bond, —C(R¹⁰R¹¹)—S—, —O—, or —N(R¹²)—, wherein R¹⁰, R¹¹, R¹² , independently are hydrogen or linear or branched C₁-C₅-alkyl;

wherein Q is an aromatic system comprising up to 3 aromatic rings, wherein the rings can independently be condensed or covalently linked, wherein the aromatic rings are independently 5- or 6-membered carbocyclic or heteroaromatic rings, at least one of which is a 5- or 6-membered heteroaromatic ring comprising at least one and up to 3 heteroatoms selected from N or S, wherein optionally Q has at least one unsubstituted carbon atom in a heteroaromatic ring in a position available for binding of an electrophilic substituent such as a Michael-type monomer, which is in vicinity to the heteroatom, wherein the system additionally can be substituted by one or more substituents selected from linear or branched C₁-C₅-alkyl, C₁-C₅-alkoxy, amino, nitro, nitroso, cyano, halogen, C₅-C₁₀ aryl, C₅-C₁₀ heteroaryl, or C₅-C₁₀ aryloxy;

wherein n is 0, 1, or 2

with the proviso that the compound is not diethyl-[(4-methyl-pyridin-2-yl)methyl]aluminum, diethyl-(2-pyridinyl-methyl)aluminum, or diethyl-(2-quinolinylmethyl)aluminum.

Preferred compounds of formula III are those wherein Q is a 5- or 6-membered heteroaromatic ring as defined above.

A further aspect of the present invention is the use of a compound of formula III for use as catalyst and/or initiator for polymerization of Michael-type monomers, in particular of demanding Michael-type monomers.

Surprisingly it was found that a catalyst and initiator compound of Formula III of the present invention as well as a compound selected from diethyl-[(4-methyl-pyridin-2-yl)methyl]aluminum or diethyl-(2-pyridinyl-methyl)aluminum, can be used for precision polymerization of any Michael-type monomer, i.e. having a substituted or unsubstituted α-position.

Thus, additionally, the present invention provides a process for polymerization of Michael-type monomers, which comprises the following steps:

a) contacting a Michael-type monomer, optionally dissolved in an organic solvent, with a bridged catalyst and initiator compound, and

b) continuing the reaction to form a polymer by reaction with at least one type of Michael-type monomer;

wherein the bridged catalyst and initiator compound is [R⁹]ₙM[Cp]₃₋ₙ or [R⁹]ₙM[-[Z³-Q]₃₋ₙ,

wherein M is aluminum, gallium or indium,

wherein Cp is cyclopentadienyl; tetramethyl-cyclopentadienyl, or pentamethyl-cyclopentadienyl;

wherein each R⁹ is independently Cl, F, I, or Br, linear, branched or cyclic alkyl, heterocycloalkyl, linear, branched, or cyclic alkenyl, heterocycloalkenyl, linear, branched, or cyclic alkinyl, heterocycloalkinyl, linear, branched, or cyclic alkoxy, aryl, heteroaryl, aryloxy, silyl, metallocenyl, nitro, nitroso, hydroxy, or carboxyl, wherein each alkyl, alkenyl, alkinyl, or alkoxy group independently has up to 12 carbon atoms, wherein each aryl independently has 5 to 10 ring atoms, wherein any hetero group has at least one hetero atom selected from O, S or N, wherein each alkyl, alkenyl, alkinyl or alkoxy, heterocycloalkyl, heterocycloalkenyl, heterocycloalkinyl, aryl, heteroaryl, aryloxy group can be substituted by 1 up to the highest possible number of halogen atoms;

Z³ is a single bond, —C(R¹⁰R¹¹)—, —S—, —O—, or —N(R¹² )—, wherein R¹⁰, R¹¹, R¹², independently are hydrogen or linear or branched C₁-C₅-alkyl;

wherein Q is an aromatic system comprising up to 3 aromatic rings, wherein the rings can independently be condensed or covalently linked, wherein the aromatic rings are independently 5- or 6-membered carbocyclic or heteroaromatic rings, at least one of which is a 5- or 6-membered heteroaromatic ring comprising at least one and up to 3 heteroatoms selected from N or S, wherein optionally Q has at least one unsubstituted carbon atom in a heteroaromatic ring in a position available for binding of an electrophilic substituent, such as a Michael-type monomer, which is in vicinity to the heteroatom, wherein the system can be substituted by one or more substituents selected from linear or branched C₁-C₅-alkyl, C₁-C₅-alkoxy, amino, nitro, nitroso, cyano, halogen, C₅-C₁₀ aryl, C₅-C₁₀ heteroaryl, or C₅-C₁₀ aryloxy;

wherein n is 0, 1, or 2.

It was found that the polymerization process of Michael-type monomers of the present invention allows polymerization providing polymers with controlled molecular weights, higher yields and lower PDI compared to the prior art in a cheaper and environmental more friendly manner. Furthermore, with the methods of the present invention and/or by using the catalyst/initiator systems of the present inventions, it is possible to control tacticity.

Moreover, the present invention provides a process for preparing a luminescent component, which comprises:

a) contacting a Michael-type monomer or an electrophilic substrate, optionally dissolved in an organic solvent, with a bridged catalyst and initiator compound, and

b) either continuing the reaction with a at least one type of Michael-type monomer to form a polymer;

c) or isolating the luminescent component, wherein the bridged catalyst and initiator compound is [R⁹]ₙM[-[Z³-Q]₃₋ₙ, wherein R⁹, n, M, Z³, and Q are as defined above with the proviso that Q has at least one unsubstituted carbon atom in a heteroaromatic ring in a position available for binding of an electrophilic substituent which is in vicinity to the heteroatom.

Surprisingly it was found that by using nitrogen containing catalyst and initiator compounds, as defined above and in the claims, and by using a process as claimed, luminescent adducts and luminescent polymers with a luminescent unit can be produced directly, i.e. by reaction with a monomer and optionally by polymerization. Without being bound by theory it is assumed that this is due to the fact that the nitrogen containing compound becomes luminescent when an electrophilic unit or element or group is added to a heteroaromatic ring of the Q in vicinity to the heteroatom and contributes to the a π electron system. The electrophilic unit or element or group is for example a Michael-type monomer. It can be any unit, element or group that contributes π electrons resulting in a conjugated system with the aromatic ring. It can also be a group that is luminescent, such as a fluorescent marker group. Examples for suitable luminescent groups are coumarine, fluorescein, rhodamine or derivatives thereof.

Thus, with the above method it is not only possible to produce polymers in an environmentally friendly and cheap manner and in high yields, with controlled molecular mass but also with desirable further functions, in particular with a luminescent group.

Moreover, the present invention provides polymers which are obtainable with the inventive process.

The inventive polymers are biocompatible and the fluorescent properties, e.g. the fluorescence color, can be controlled by the inventive process.

The catalyst and initiator compound have several advantages compared to compounds used in the prior art. They are cheaper and more efficient and they lack a rare metal or noble metal for catalysis.

It is assumed that the reaction between catalyst/initiator system of the present invention and Michael-type monomer occurs via a new mechanism. Without being bound by theory, Scheme 3 show a proposed mechanistic pathway of the polymerization of Michael-type monomer via the bridged heterocyclic catalyst and initiator compound of

Formula III of the present invention, which provides a direct initiation and catalysis. The first species which is shown in scheme 3 provides kinetic advantages which are likely to result from a concerted activation pathway between monomer, initiator and catalyst. The catalyst of Formula III includes a Lewis acid part (metal) and a Lewis base part (aromatic heterocycle) in one molecule. Due to the cooperative interactions of Lewis acid and Lewis base parts, the polymerization is thermodynamically favored, since the loss of entropy for building the active species is reduced in comparison to a frustrated Lewis acid-monomer-Lewis base system. The initiating part which can be any heterocyclic aromatic residue as defined herein (Lewis Base) nucleophilicly attacks the β-δ⁺-position of the advanced Michael-type monomer (in Scheme 3: acrylamide) which is weakly coordinated to the metal center. The metal center (Lewis acid) catalyzes the chain propagation by a group transfer polymerization. Additionally the pathway using bridged catalysts enables the production of Michael-type-polymers having heterocyclic aromatic end groups for further functionalization.

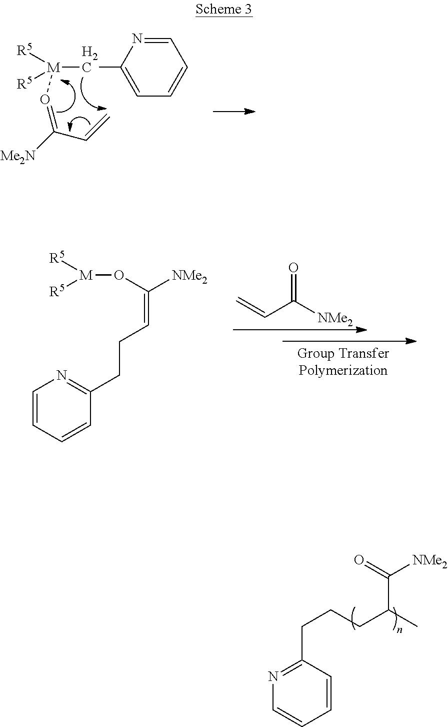

The metal M of the compound of Formula III can be Al, Ga or In. It is very important that the metal has Lewis acidic properties. For the polymerization mechanism of the present invention, metals with three valences can be used, which are bound in a bridged structure together with an initiator compound, which is the Lewis base. Thus, the Lewis acid has a free coordination site because of an electron sextet. After being cleaved off from the initiating compound (aromatic heterocycle), Lewis acidity even increases since an electron quartet is formed temporarily around the metal which also increases the catalytic activity and therefore the turnover numbers. Therefore, chain propagation reaction can yield high molecular weight polymers in short time and large quantities.

R⁹ of the catalytic and initiating compound has the property of adjusting the Lewis acid strength of the metal center. This means, if R⁹ is an electron withdrawing group (EWG), the Lewis acidity is increased, vice versa the Lewis acidity is decreased if R⁹ is an electron donating group. Therefore, the Lewis acidity can be adjusted accordingly to the chemical polymerization requirements of a Michael-type monomer. However, it is very important that the Lewis acidity is not too high i.e. the binding of the Lewis acid or catalyst site to the initiator or Lewis base should not be too strong. Vice versa, binding should not be too weak which would cause a dissociation before the nucleophilic attack of the initiating part can take place.

Furthermore, substituents Z³ and Q of the Lewis base are, without being bound by theory, responsible for the strength of the Lewis base part of the compound of formula III. Z³ and Q are responsible for the steric interaction between the catalyst and initiator compound in front of the monomer. This mechanism also allows to control tacticity. It hasbeen found that atactic polymers are obtained when the substituents of Z³ and Q are neutral or electron withdrawing and that syndiotactic polymers can be obtained when the substituents of Z³ and Q are electron donating, like alkyl, cycloalkyl, aryl.

In addition, the substituents Z³ and Q are responsible for the nucleophilicity i.e. Lewis basicity of the heterocyclic group. Therefore, an analoguous principle for the adjustment of the Lewis basicity applies for the nucleophilic heterocyclic group. Thus, the group's nucleophilicity can be adjusted if monomers which have to be polymerized have different electrophilic behavior. Furthermore, the initiator part of the bridged catalyst in formula III has to be nucleophilic; on the other hand, the Lewis base part should not provide strong Bronsted base characteristics.

Moreover, substituents of Z³ and Q of a compound of formula III can also influence luminescence of a compound of formula III. The more substituents contribute π electrons and the more conjugation is provided the more the wavelength of luminescence is shifted to UV light. Thus, the color can be controlled by adapting substitutents. Moreover, it has been found that with the process of the present invention or when using a catalyst/initiator of the present invention it is possible to obtain polymers providing luminescence with a quantum Yield of up to 95%.

In the following examples for heteroaromatic bridged catalyst and initiator compounds of formula III are shown:

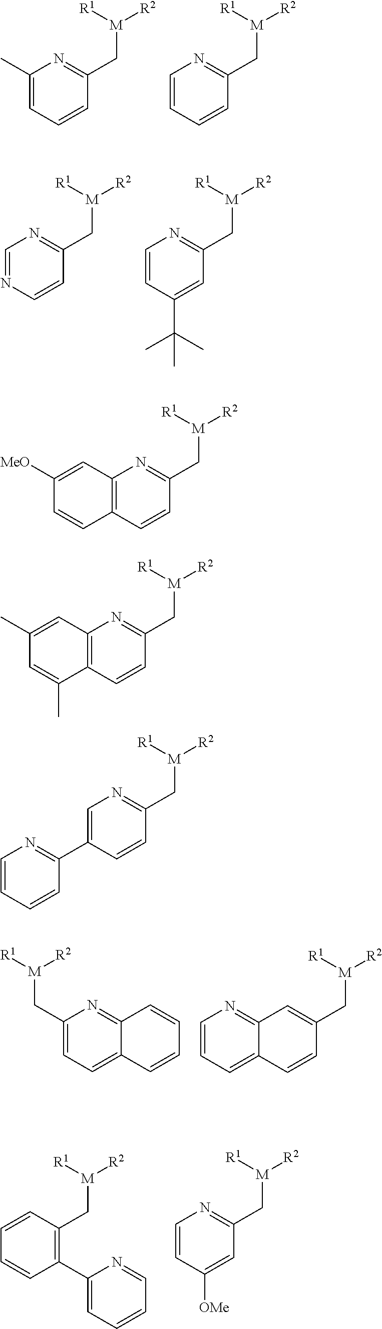

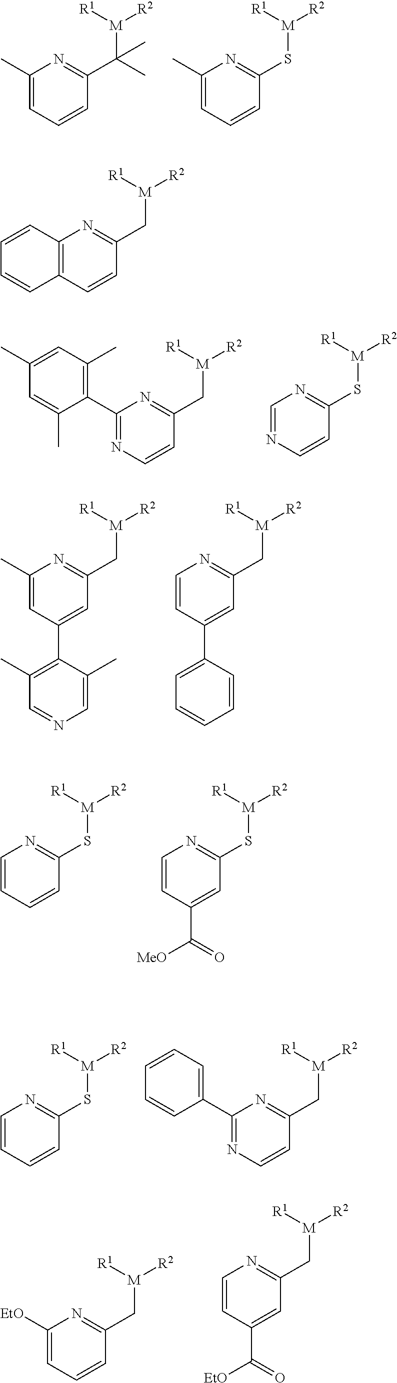

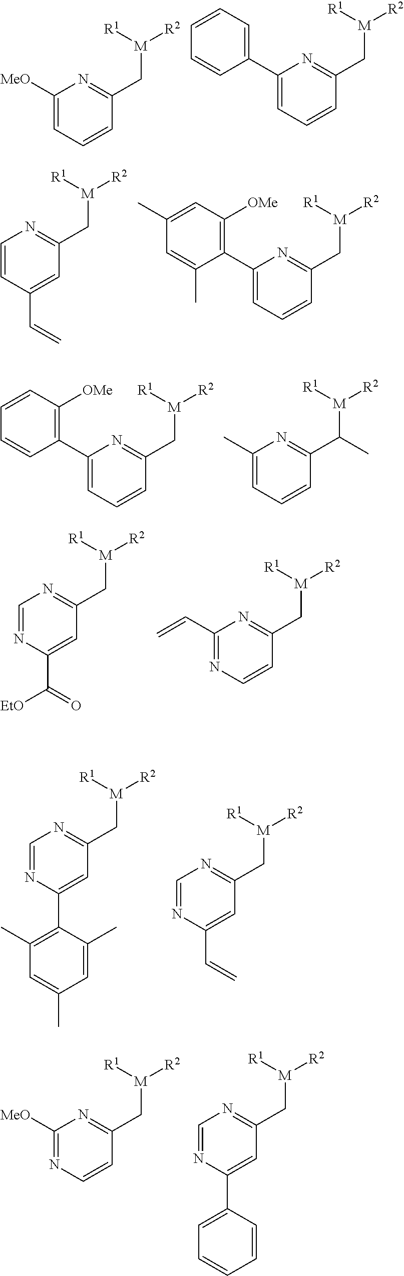

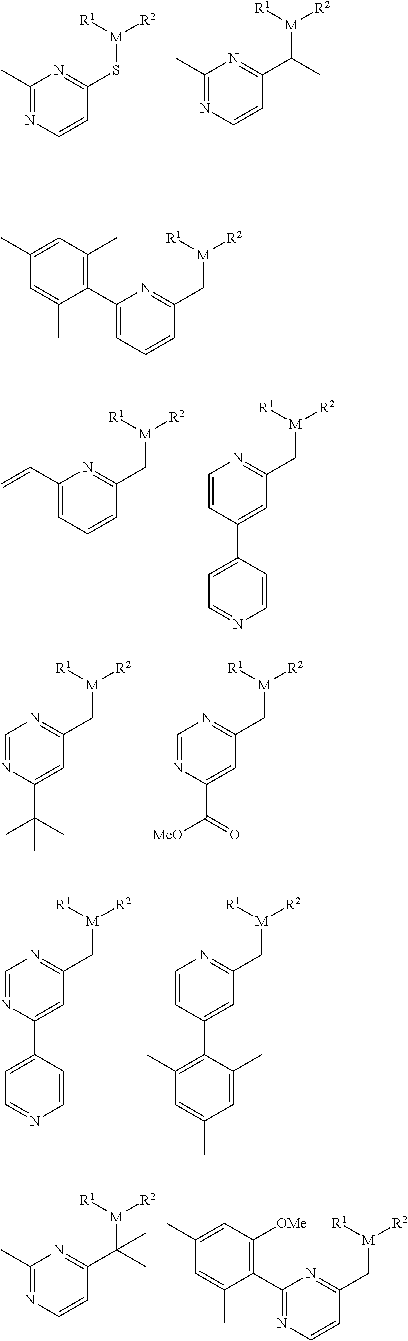

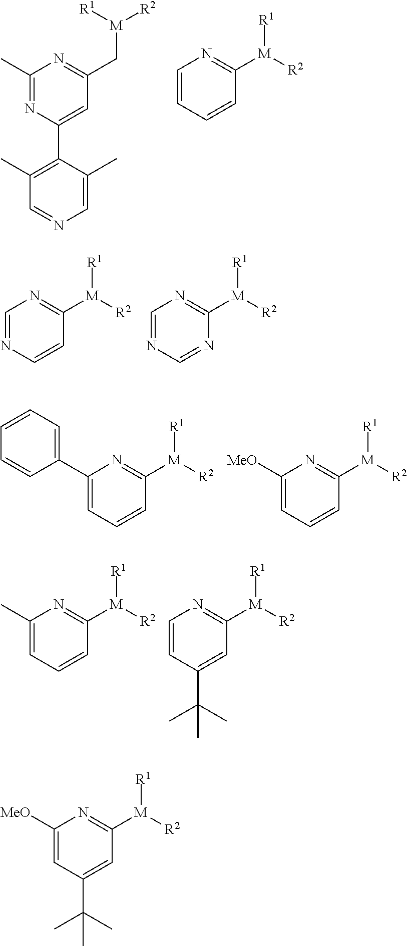

All the above compounds comprise an aromatic system with at least one heteroaromatic ring. These compounds can be used as bridged catalyst and initiator compound in a process for preparing a luminescent compound.

The inventive catalyst and initiator compound can be used for polymerization catalysis of any Michael-type monomer or monomer mixtures to yield polymers or copolymers regardless of the substitution. Preferably the Michael-type monomers are selected from vinylphosphonates, in particular diethylvinylphosphonate, or diisopropylvinylphosphonate; vinylsulfonates, substituted or unsubstituted acrylates and methacrylates, such as butyl acrylate, isobutyl acrylate, tert.-butyl acrylate, isobornyl acrylate, furfuryl acrylate, glydidyl acrylate; substituted or unsubstituted acrylamides, such as methacrylamide, dimethylacrylamide, acrylonitrile, or vinylpyridines, vinyl ketones, acrolein and acrolein derivates or a mixture thereof.

Additionally, the present invention provides a process for polymerization of Michael-type monomers, comprising:

a) contacting a Michael-type monomer, optionally dissolved in an organic solvent, with a bridged catalyst and initiator compound, and

b) continuing the reaction to form a polymer by reaction with a Michael-type monomer;

wherein the bridged catalyst and initiator compound is [R⁹]ₙM[Cp]₃₋ₙ or [R⁹]ₙM[-[Z³-Q]₃₋ₙ, wherein M is aluminum, gallium or indium, wherein Cp is cyclopentadienyl, tetramethyl cyclopentadienyl, or pentamethyl cyclopentadienyl;
wherein each R⁹ is independently Cl, F, I, or Br, linear, branched or cyclic alkyl, heterocycloalkyl, linear, branced or cyclic alkenyl, heterocycloalkenyl, linear, branched, or cyclic alkenyl, heterocycloalkenyl, linear, branched, or cyclic alkenyl, heterocycloalkinyl, linear, branched, or cyclic alkoxy, aryl, heteroaryl, aryloxy, silyl, metallocenyl, nitro, nitroso, hydroxy, or carboxyl, wherein each alkyl, alkenyl, or alkenyl group independently has up to 12 carbon atoms, wherein each aryl independently has 5 to 10 carbon atoms, wherein any hetero group has at least one hetero atom selected from O, S or N, wherein each alkyl, alkenyl, alkenyl or alkoxy, heterocycloalkyl, heterocycloalkenyl, heterocycloalkinyl, aryl, heteroaryl, aryloxy group can be substituted by 1 up to the highest possible number of halogen atoms;
wherein Z³ is a single bond, —C(R¹⁰R¹¹)—, —S—, —O—, or —N(R¹²)—, wherein R¹⁰, R¹¹, R¹², independently are hydrogen or linear or branched C₁-C₅-alkyl;
wherein Q is an aromatic system comprising up to 3 aromatic rings, wherein the rings can independently be condensed or covalently linked, wherein the aromatic rings are independently 5- or 6-membered carbocyclic or heteroaromatic rings, at least one of which is a 5- or 6-membered heteroaromatic ring comprising at least one and up to 3 heteroatoms selected from N or S, wherein optionally Q has at least one unsubstituted carbon atom in a heteroaromatic ring in a position available for binding of an electrophilic substituent which is in vicinity to the heteroatom, wherein the system can be substituted by one or more substituents selected from linear or branched C₁-C₅-alkyl, C₁-C₅-alkoxy, amino, nitro, nitroso, cyano, halogen, C₅-C₁₀ aryl, C₅-C₁₀ heteroaryl, or C₅-C₁₀ aryloxy; wherein n is 1 or 2.

In step a) of the this process a Michael-type monomer is contacted with a bridged catalyst and initiator compound [R⁹]ₙM[Cp]₃₋ₙ or [R⁹]ₙM[-[Z³-Q]₃₋ₙ as defined before. The reaction can be optionally carried out in an organic solvent. Suitable solvents are known to the skilled artisan and those that are commonly used in such processes can be used here as well. The optimal solvent depends from the catalyst and monomer used. Suitable are for example THF and toluene.

Step b) of the inventive process can be carried out with other Michael-type monomers or the same Michael-type monomers as used in step a). Due to the inventive process, polymers or copolymers of Michael-type monomers can be produced easily. Without being bound to a particular theory, it is assumed that the reaction proceeds via a pathway as proposed in Scheme 3.

The polymerization method using heteroatom containing catalytic active compounds can be used for all Michael-type monomers as with the above described processes, i.e. for Michael-type monomers substituted in α-position or not. Monomers that in particular can be polymerized are selected from vinylphosphonate, in particular diethylvinylphosphonate, or diisopropylvinylphosphonate; vinylsulfonate, substituted or unsubstituted acrylate and methacrylate, such as butyl acrylate, isobutyl acrylate, tert.-butyl acrylate, isobornyl acrylate, furfuryl acrylate, glydidyl acrylate; substituted or unsubstituted acrylamide, such as methacrylamide, dimethylacrylamide, acrylonitrile, vinylpyridine, vinyl ketone, acrolein or an acrolein derivative or any mixture thereof.

The process of the invention allows high polymeric yields of at least 80% of the after conversion of the Michael-type monomers. Preferably polymeric yields are between between 90 and 100%. More preferably polymeric yields are 100%.

Furthermore, it was found that catalyst activity, polymer yield, molecular mass of the final polymer and polydispersity index are dependent from the molar ratio of monomer to catalyst system, in other words the catalyst loading. It was found, that a catalyst loading in a molar ratio of monomer/catalyst of less than 1000 results in a high yield, nearly stoichiometric monomer consumption and a low molecular mass. Thus, the catalyst of the present invention can for example be used in a monomer to catalyst and initiator ratio of between 50 g and 5000, such as 100 to 1000.

The present invention also provides a process for preparing a luminescent component, comprising:

a) contacting a Michael-type monomer or an electrophilic substrate, optionally dissolved in an organic solvent, with a bridged catalyst and initiator compound, and

b) optionally continuing the reaction with a at least one Michael-type monomer to form a polymer;

wherein the bridged catalyst and initiator compound is [R⁹]ₙM[-[Z³-Q]₃₋ₙ, wherein R⁹, n, M, Z³ and Q are as defined before with the proviso that Q has at least one unsubstituted carbon atom in a heteroaromatic ring in a position available for binding of an electrophilic substituent which is in vicinity to the heteroatom.

In step a) of the inventive process a catalyst and initiator compound as defined is contacted with a Michael-type monomer. For the preparation of a luminescent polymer, it is important, that Q of [R⁹]ₙM[-[Z³-Q]₃₋ₙ has an unsubstituted carbon atom. Without being bound to a theory, a mechanism for the formation of the catalyst and initiator compound in step a) prior to the initiation of the polymerization reaction is illustrated in Scheme 4. Prior to the initiation step of the polymerization, the Lewis base heterocycle is substituted by the Michael-type monomer. After this substitution, the polymerization proceeds with step b) in the same Mechanistic manner as shown in Scheme 3. The Michael-type monomer which electrophilicly substitutes the initiator part of the catalyst remains as end group after the polymerization. This results in a luminescence of the polymer due to the heteroaromatic system. The Michael-type substituent which takes not part in the polymerization, but electrophilicly substitutes the terminal heteroaromatic polymer group, enables an enhancement of the aromaticity and conjugation. Thus, the enhanced conjugation of the terminal group of the polymer is responsible for luminescence.

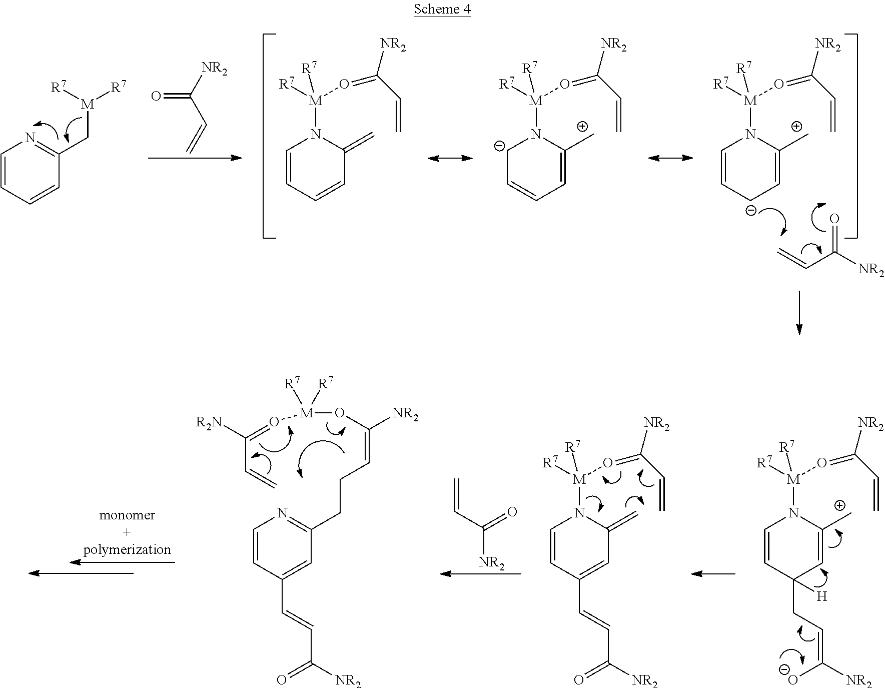

The process for preparing luminescent polymers corresponds to the processes as defined above. It was found that just by using a specific type of catalyst and initiator compound components having luminescence can be obtained. The process can be carried out with the same parameters as the process defined above. Color of the luminescent polymer can range over the whole visible spectra. The color can for example be red, blue, green, yellow, orange, or violet.

In one embodiment a green luminescent polymer can be produced by contacting dimethyl-alpha-lutidylaluminum with dimethylmetacrylate in a organic solvent and further continuing polymerization.

A further aspect of the present invention are the luminescent components obtainable by the above described process. The polymers obtained are biocompatible and the luminescent properties, e.g. fluorescence, color, can be controlled by choosing catalyst and monomers as described above.

Without being bound by theory, it is assumed that the luminescence of the components results from the terminal group, i.e. the electrophilicly substituted heterocycle which is the initiator for the polymerization reaction.

The color can be adjusted for any Michael-type polymer by choosing the initiator Lewis base and/or choosing the Michael-type monomer for electrophilic substitution. The desired luminescence color can be easily calculated by the absorption increments of respective substituents according to the Woodward-Fieser-rules which are known to the person skilled in the art. The polymer attached to the luminescent end group is not critical for the color of the polymer.

With the catalytic active compounds and processes of the present invention polymers with many favourable properties can be obtained. These polymers can be used in many different fields, such as, photocatalytic reduction, optical fiber waveguides, pH-sensing, temperature sensing, molecular-recognition processes with photonic (fluorescence) signals, phase transfer catalysis, photoluminescent magnetic sensor (via complexation of magnetic metals), photoluminescence quenching assays, as for example developed for the analysis of proteins, among others.

In the following some embodiments are outlined:

1. Catalyst and initiator compound for precision polymerization of Michael-type monomers, represented by the following structures:

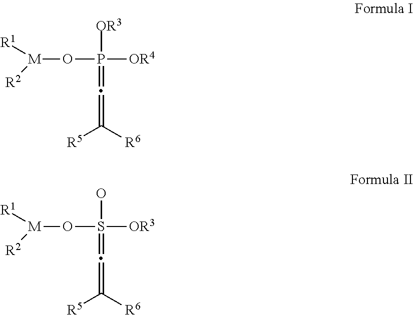

wherein M is Al, B, Ga, or In;
each R¹ and R² is independently Cl, F, I, Br, or linear, branched or cyclic alkyl, heterocycloalkyl, linear, branched or cyclic alkenyl, heterocycloalkenyl, linear, branched, or cyclic alkenyl, linear, branched, or cyclic alkinyl, heterocycloalkinyl, linear, branched, or cyclic alkoxy, aryl, heteroaryl, aryloxy, silyl, metallocenyl, nitro, nitroso, hydroxy, or carboxyl, wherein each alkyl, alkenyl, alkinyl or alkoxy independently has up to 12 carbon atoms, wherein each aryl or heteroaryl independently has 5 to 10 ring atoms, wherein any hetero group has at least one hetero atom selected from O, S or N, wherein each alkyl, alkenyl, alkinyl or alkoxy, heterocycloalkyl, heterocycloalkenyl, heterocycloalkinyl, aryl, heteroaryl, aryloxy group can be substituted by 1 up to the highest possible number of halogen atoms; each R³ and R⁴ is independently linear or branched alkyl with a maximum carbon atom number of 4; and
R⁵ and R⁶ are independently hydrogen or defined as R¹ and R².
   2. Catalyst and initiator for precision polymerization according to paragraph 1, wherein the compound is selected from

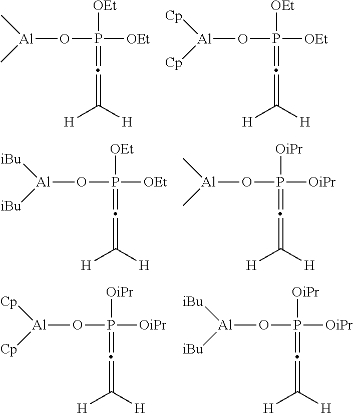

3. A process for precision polymerization of Michael-type monomers comprising:
a) contacting an α-acidic Michael-type monomer, optionally dissolved in an organic solvent, with a bridged precatalyst system comprising a Lewis acid and a Lewis base, whereby a bridged initiator and catalyst is formed, and
b) continuing the reaction to form a polymer by reaction with at least one type of an α-acidic or non-α-acidic Michael-type monomer;
wherein the bridged precatalyst comprises a Lewis acid part [R¹R²M]⁺, and a Lewis base part [Z¹PZ₂]⁻ or [Z¹SZ]⁻, covalently linked via Z¹;
wherein in the Lewis acid part [R¹R²M]⁺ M is Al, Ga, or In; each R¹ and R² is independently Cl, F, I, Br or linear, branched or cyclic alkyl, heterocycloalkyl, linear, branched or cyclic alkenyl, heterocycloalkenyl, linear, branched, or cyclic alkinyl, heterocycloalkinyl, linear, branched, or cyclic alkoxy, aryl, heteroaryl, aryloxy, silyl, metallocenyl, nitro, nitroso, hydroxy, or carboxyl, wherein each alkyl, alkenyl, alkinyl, or alkoxy independently has up to 12 carbon atoms, wherein each aryl or heteroaryl independently has 5 to 10 ring atoms, wherein any hetero group has at least one hetero atom selected from O, S or N, wherein each alkyl, alkenyl, alkinyl or alkoxy, heterocycloalkyl, heterocycloalkenyl, heterocycloalkinyl, aryl, heteroaryl, aryloxy group can be substituted by 1 up to the highest possible number of halogen atoms and
wherein in the Lewis base part [Z¹PZ₂]⁻ or [Z¹SZ]⁻ each Z independently is a linear, branched, or cyclic alkyl, alkenyl, or alkinyl group, or heteroalkyl, heteroalkenyl, or heteroalkinyl, group, having up to 12 carbon atoms; or a donor substituted aryl or heteroaryl group having 5 to 10 ring atoms; wherein any hetero group comprises at least one hetero atom selected from O, S or N and
wherein Z¹⁻ is —C(R¹⁰R¹¹)—, —S—, —O—, or —N(R¹²)—, wherein R¹⁰, R¹¹, R¹², independently e hydrogen or linear or branched C₁-C₅-alkyl.
   4. Process according to paragraph 3, wherein Michael-type monomers used in step a) and in step b) can be the same or different, and wherein in step b) one or more types of Michael-type monomers can be used.
   5. Process according to any of paragraphs 3 or 4, wherein the α-acidic Michael-type monomer of step a) is independently selected from the group consisting of vinylphosphonates, in particular diethylvinylphosphonate, or diisopropylvinylphosphonate, vinylsulfonates, acrylates, acrylonitrile, or vinylpyridines. and/or wherein the at least one Michael-type monomer of step b) is independently selected from the group consisting of vinylphosphonates, in particular diethylvinylphosphonate, or diisopropylvinylphosphonate; vinylsulfonates, substituted or unsubstituted acrylates and methacrylates, such as butyl acrylate, isobutyl acrylate, tert.-butyl acrylate, isobornyl acrylate, furfuryl acrylate, glydidyl acrylate; substituted or unsubstituted acrylamides, such as methacrylamide, dimethylacrylamide, acrylonitrile, or vinylpyridines, vinyl ketones, acrolein and acrolein derivates.
   6. Process according to any of paragraphs 3 to 5, wherein the bridged precatalyst system is selected from the group of

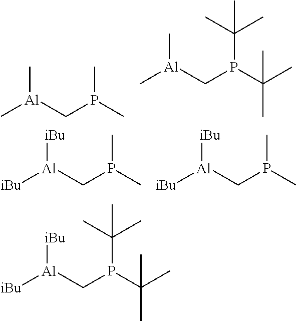

7. Process according to any of paragraphs 3 to 7, wherein the monomer of at least one of steps a) and b) is 4-vinylpyridine and wherein the precatalyst comprises Me₂AlCH₂P(t-Bu)₂.
8. Polymer obtainable with a process of one of paragraphs 3 to 7.
9. Polymer according to paragraph 8, wherein the polymer is a polymer or copolymer of one or more of Michael monomers selected from the group consisting of vinylphosphonate, in particular diethylvinylphosphonate, or diisopropylvinyl-phosphonate; vinylsulfonate, substituted or unsubstituted acrylate and methacrylate, such as butyl acrylate, isobutyl acrylate, tert.-butyl acrylate, isobornyl acrylate, furfuryl acrylate, glydidyl acrylate; substituted or unsubstituted acrylamide, such as methacrylamide, dimethylacrylamide, acrylonitrile, vinylpyridine, vinyl ketone, acrolein or an acrolein derivate.
10. Precatalytic bridged complex having formula R¹R²MZ¹PZ₂ or R¹R²MZ¹SZ, wherein a Lewis acid part R¹R²M and a Lewis base part, PZ₂ or SZ, are covalently linked via a bridge Z¹, wherein M is Al, Ga, or In; each R¹ and R² is independently Cl, F, I, Br or linear, branched or cyclic alkyl, heterocycloalkyl, linear, branched or cyclic alkenyl, heterocycloalkenyl, linear, branched, or cyclic alkinyl, heterocycloalkinyl, linear, branched, or cyclic alkoxy, aryl, heteroaryl, aryloxy, silyl, metallocenyl, nitro, nitroso, hydroxy, or carboxyl, wherein each alkyl, alkenyl, or alkenyl group independently has up to 12 carbon atoms, wherein each aryl or heteroaryl independently has 5 to 10 ring atoms, wherein any hetero group has at least one hetero atom selected from O, S or N, wherein each alkyl, alkenyl, alkinyl or alkoxy, heterocycloalkyl, heterocycloalkenyl, heterocycloalkinyl, aryl, heteroaryl, aryloxy group can be substituted by 1 up to the highest possible number of halogen atoms and
wherein each Z independently is a linear, branched, or cyclic alkyl, alkenyl, or alkinyl group, or heteroalkyl, heteroalkenyl, or heteroalkinyl group, having up to 12 carbon atoms; or a donor substituted aryl or heteroaryl group having 5 to 10 ring atoms, wherein any hetero group comprises at least one hetero atom selected from O, S or N and wherein Z¹⁻ is —C(R⁶R⁷)—, —S—, —O—. —N(R⁸)—, wherein R⁶, R⁷, R⁸, independently are hydrogen or linear or branched C₁-C₅-alkyl;
with the proviso that the compound is not (dimethyl phosphinomethyl)dimethyl aluminum.
   11. System for precision polymerization, comprising
a) an α-acidic Michael-type monomer,
b) a precatalyst having formula R¹R²MZ¹PZ₂ or R¹R²MZ¹SZ comprising a Lewis acid part [R¹R²M]⁺, as catalyst, and a Lewis base part [Z¹PZ₂]⁻ or [Z¹SZ]⁻ covalently combined in one molecule,
c) optionally an organic solvent,
wherein components a) and b) can form an active initiator and catalyst complex,
wherein a Lewis acid part R¹R²M and a Lewis base part, PZ₂ or SZ, are covalently linked via a bridge Z¹, wherein M is Al, Ga, or In; each R¹ and R² is independently Cl, F, I, Br or linear, branched or cyclic alkyl, heterocycloalkyl, linear, branched or cyclic alkenyl, heterocycloalkenyl, linear, branched, or cyclic alkinyl, heterocycloalkinyl, linear, branched, or cyclic alkoxy, aryl, heteroaryl, aryloxy, silyl, metallocenyl, nitro, nitroso, hydroxy, or carboxyl, wherein each alkyl, alkenyl, alkinyl, or alkoxygroup independently has up to 12 carbon atoms, wherein each aryl independently has 5 to 10 ring atoms, wherein any hetero group has at least one hetero atom selected from O, S or N, wherein each alkyl, alkenyl, alkenyl or alkoxy, heterocycloalkyl, heterocycloalkenyl, heterocycloalkinyl, aryl, heteroaryl, aryloxy group can be substituted by 1 up to the highest possible number of halogen atoms and wherein each Z independently is a linear, branched, or cyclic alkyl, alkenyl, or alkinyl group, or heteroalkyl, heteroalkenyl, or heteroalkinyl, group, having up to 12 carbon atoms; or a donor substituted aryl or heteroaryl group having 5 to 10 ring atoms, wherein any hetero group comprises at least one hetero atom selected from O, S or N and wherein Z¹⁻ is —C(R⁶R⁷)—, —S—, —O—, or —N(R⁸)—, wherein R⁶, R⁷, R⁸, independently are hydrogen or linear or branched C₁-C₅-alkyl.
   12. System for precision polymerization according to paragraph 11, comprising 4-vinylpyridine as a monomer and Me₂AlCH₂PtBu₂ as precatalyst system; or diethylvinylphosphonate and Me₂AlCH₂PMe₂ as precatalyst system.
   13. Process for preparing a bridged initiator and catalyst of formula I or II comprising contacting an α-acidic Michael-type monomer, optionally dissolved in an organic solvent, with a precatalyst, having formula R¹R²MZ¹PZ₂ or R¹R²MZ¹SZ in a molar ratio of precatalyst to monomer of 1:1 to 2:1, whereby a bridged initiator and catalyst is formed, wherein R¹, R², M, Z¹, Z are as defined in paragraph 10, wherein optionally the α-acidic Michael-type monomer is selected from vinylphosphonates, in particular diethylvinylphosphonate, or diisopropylvinylphosphonate; vinylsulfonates, substituted or unsubstituted acrylates and methacrylates, such as butyl acrylate, isobutyl acrylate, tert.-butyl acrylate, isobornyl acrylate, furfuryl acrylate, glydidyl acrylate; substituted or unsubstituted acrylamides, such as methacrylamide, dimethylacrylamide, acrylonitrile, or vinylpyridines, vinyl ketones, acrolein and acrolein derivates or mixtures thereof.
   14. Catalyst and initiatorinitiator compound for the polymerization of Michael-type monomers, comprising a structure represented by the following formula:

[R⁹]ₙM-[Z³-Q]₃₋ₙ Formula III

wherein M is Al, Ga, or In;
wherein each R⁹ is independently Cl, F, I, or Br, linear, branched or cyclic alkyl, heterocycloalkyl, linear, branched or cyclic alkenyl, heterocycloalkenyl, linear, branched, or cyclic alkinyl, heterocycloalkinyl, linear, branched, or cyclic alkoxy, aryl, heteroaryl, aryloxy, silyl, metallocenyl, nitro, nitroso, hydroxy, or carboxyl, wherein each alkyl, alkenyl, alkinyl, or alkoxy independently has up to 12 carbon atoms, wherein each aryl independently has 5 to 10 ring atoms, wherein any hetero group has at least one hetero atom selected from O, S or N, wherein each alkyl, alkenyl, alkinyl or alkoxy, heterocycloalkyl, heterocycloalkenyl, heterocycloalkinyl, aryl, heteroaryl, aryloxy group can be substituted by 1 up to the highest possible number of halogen atoms;
wherein Z³ is a single bond, —C(R¹⁰R¹¹)—, —S—, —O—, or —N(R¹²)—, wherein R¹⁰, R¹¹, R¹², independently are hydrogen or linear or branched C₁-C₅-alkyl;
   wherein Q is an aromatic system comprising up to 3 aromatic rings, wherein the rings can independently be condensed or covalently linked, wherein the aromatic rings are independently 5- or 6-membered carbocyclic or heteroaromatic rings, at least one of which is a 5- or 6-membered heteroaromatic ring comprising at least one and up to 3 heteroatoms selected from N or S, wherein optionally Q has at least one unsubstituted carbon atom in a heteroaromatic ring in a position available for binding of an electrophilic substituent which is in vicinity to the heteroatom, wherein the system additionally can be substituted by one or more substituents selected from linear or branched C₁-C₅-alkyl, C₁-C₅-alkoxy, amino, nitro, nitroso, cyano, halogen, C₅-C₁₀ aryl, C₅-C₁₀ heteroaryl, or C₅-C₁₀ aryloxy;
wherein n is 0, 1, or 2
with the proviso that the compound is not diethyl-[(4-methyl-pyridin-2-y)-methyl]aluminum, diethyl-(2-pyridinylmethyl)aluminum, or diethyl(quinolin-2-ylmethyl)aluminum
   15. Catalyst and initiator compound according to paragraph 14 wherein the compound is selected from the group as defined above.
   16. Catalyst and initiator compound according to paragraphs 14 or 15, wherein a Michael-type monomer is bound at an unsubstituted carbon atom in a heteroaromatic ring of Q in a position available for binding of an electrophilic substituent which is in vicinity to the heteroatom, wherein this substitution of Q is in ortho or para position relative to the position of N.
   17. Process for polymerization of Michael-type monomers, comprising:
a) contacting a Michael-type monomer, optionally dissolved in an organic solvent, with a bridged catalyst and initiator compound, and
b) continuing the reaction to form a polymer by reaction with at least one type of Michael-type monomer;
wherein the bridged catalyst and initiator compound is

[R⁹]ₙM[Cp]₃₋ₙ or [R⁹]ⁿM[-[Z³-Q]₃₋ₙ,
wherein Cp is cyclopentadienyl, tetramethylcyclopentadienyl, or pentacyclopenta-dienyl,
wherein M is aluminum, gallium or indium, wherein each R⁹ is independently Cl, F, I, or Br, linear, branched or cyclic alkyl, heterocycloalkyl, linear, branched, or cyclic alkenyl, heterocycloalkenyl, linear, branched, or cyclic alkinyl, heterocycloalkinyl, linear, branched, or cyclic alkoxy, aryl, heteroaryl, aryloxy, silyl, metallocenyl, nitro, nitroso, hydroxy, or carboxyl, wherein each alkyl, alkenyl, alkinyl, or alkoxy group independently has up to 12 carbon atoms, wherein each aryl independently has 5 to 10 ring atoms, wherein any hetero group has at least one hetero atom selected from O, S or N, wherein each alkyl, alkenyl, alkinyl or alkoxy, heterocycloalkyl, heterocycloalkenyl, heterocycloalkinyl, aryl, heteroaryl, aryloxy group can be substituted by 1 up to the highest possible number of halogen atoms;
Z³ is a single bond, —C(R10R¹¹)—, —S—, —O—, or —N(R¹²)—, wherein R¹⁰, R¹¹, R¹², independently are hydrogen or linear or branched C₁-C₅-alkyl;
wherein Q is an aromatic system comprising up to 3 aromatic rings, wherein the rings can independently be condensed or covalently linked, wherein the aromatic rings are independently 5- or 6-membered carbocyclic or heteroaromatic rings, at least one of which is a 5- or 6-membered heteroaromatic ring comprising at least one and up to 3 heteroatoms selected from N or S, wherein optionally Q has at least one unsubstituted carbon atom in a heteroaromatic ring in a position available for binding of an electrophilic substituent which is in vicinity to the heteroatom, wherein the system can be substituted by one or more substituents selected from linear or branched C₁-C₅-alkyl, C₁-C₅-alkoxy, amino, nitro, nitroso, cyano, halogen, C₅-C₁₀ aryl, C₅-C₁₀ heteroaryl, or C₅-C₁₀ aryloxy
wherein n is 0, 1, or 2.
   18. Process according to paragraph 17, wherein Michael-type monomers used in step a) and in step b) can be the same or different, and wherein in step b) one or more types of Michael-type monomers can be used.
   19. Process according to any of paragraphs 17 or 18, wherein the Michael-type monomers are independently selected from the group consisting of vinylphosphonates, in particular diethylvinylphosphonate, or diisopropylvinylphosphonate; vinylsulfonates, substituted or unsubstituted acrylates and methacrylates, such as butyl acrylate, isobutyl acrylate, tert.-butyl acrylate, isobornyl acrylate, furfuryl acrylate, glydidyl acrylate; substituted or unsubstituted acrylamides, such as methacrylamide, dimethylacrylamide, acrylonitrile, or vinylpyridines, vinyl ketones, acrolein and acrolein derivates.
   20. Process according to any of paragraphs 17 to 19, wherein the catalyst and initiator compound is selected from the group of compounds as defined in paragraph 16.
   21. Process for preparing a luminescent component, comprising:
a) contacting a Michael-type monomer or an electrophilic substrate, optionally dissolved in an organic solvent, with a bridged catalyst and initiator compound, and
b) optionally continuing the reaction with a at least one Michael-type monomer to form a polymer;
wherein the bridged catalyst and initiator compound is [R⁹]ₙM[-[Z³-Q]₃₋ₙ, wherein R⁹, n, M, Z³, and Q are as defined in paragraph 17, with the proviso that Q has at least one unsubstituted carbon atom in a heteroaromatic ring in a position available for binding of an electrophilic substituent which is in vicinity to the heteroatom.
   22. Polymer, obtainable with a process of one of paragraphs 17 to 21.
   23. Luminescent polymer obtainable with the process of paragraph 22.
   24. Luminescent component obtainable with the process of paragraph 21.

### EXAMPLES

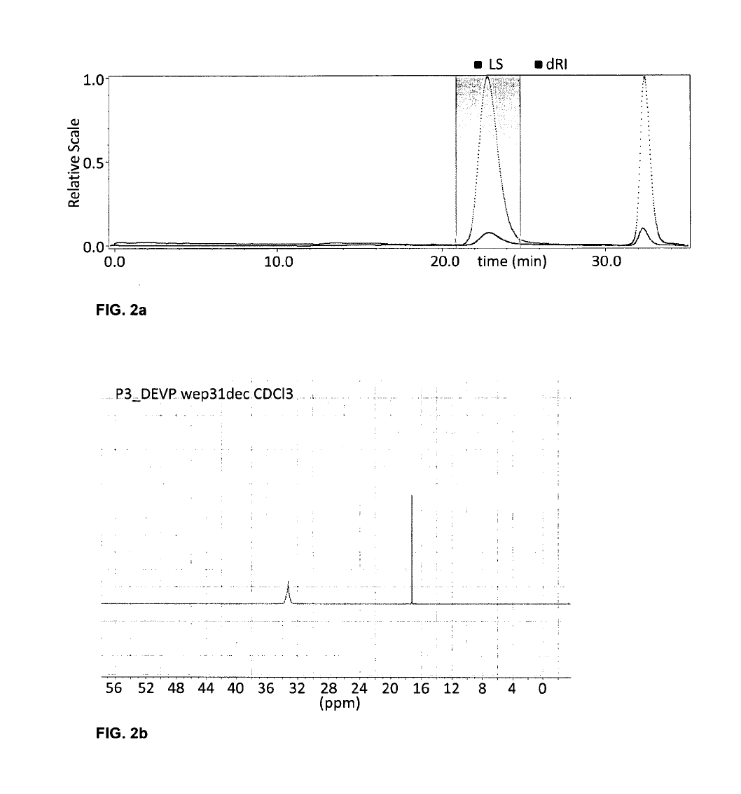

Gel permeation chromatography detection was made using a WTC Dawn Heleos II MALS detector. GPC was carried out on a Varian LC-920 system with two PL polar gel columns and N,N-dimethyl formamide (0.025 M LiBr) (polyacrylonitrile) or tetrahydrofurane/water (0.025 M tetrabutylammoniumbromide) (vinylphosphonates and vinylpyridines)) were used as liquid medium. The retention times were recorded via a MALLS detector and via an integrated RI detector (356-LC). The GPC spectrum is shown in FIG. 2.

The NMR spectra were recorded with an AV III 500C of Bruker and were evaluated with Top Spin 3 software.

In the following examples specific embodiments of the present invention are shown without thereby limiting the scope of the invention.

Acrylonitrile, vinylphosphonates and vinylpyridines were polymerized using a bridged Lewis acid base system. The conditions and results are shown in Tables 1 and 2. The method is described in detail below.

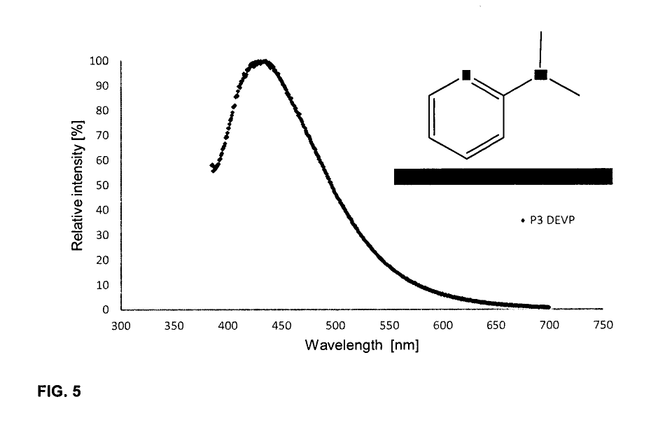

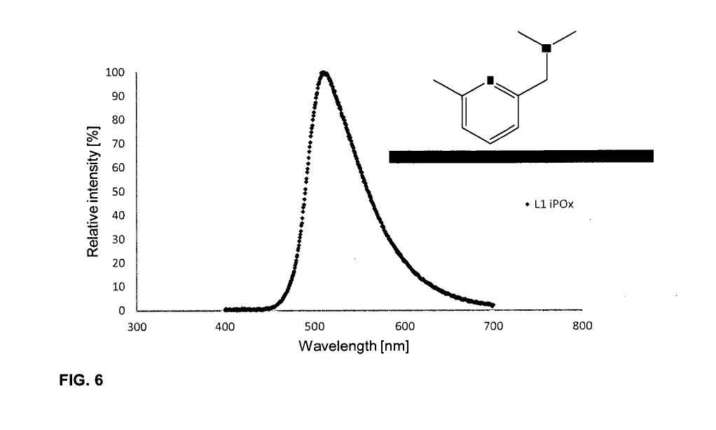

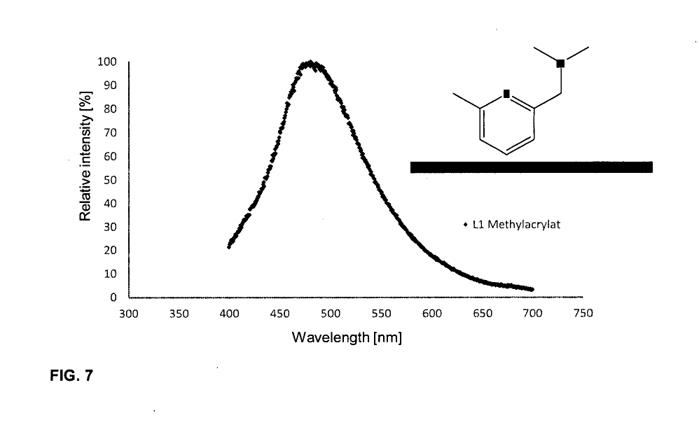

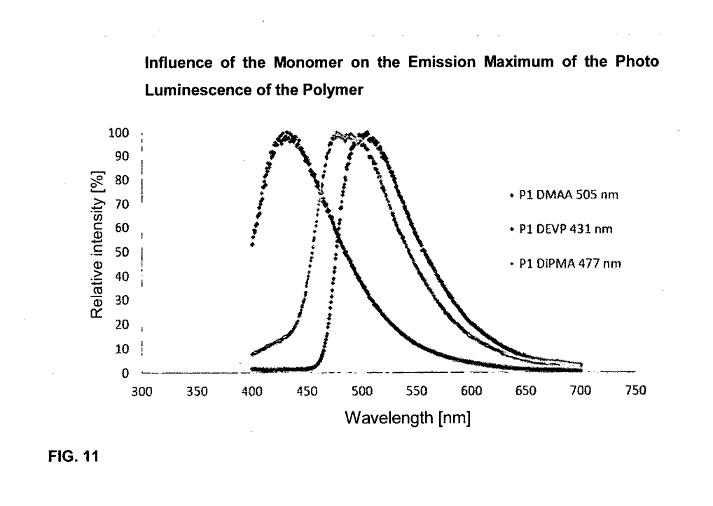

Exemplary UV/Vis spectra for luminescent compounds are shown in FIGS. 5-12.

TABLE 1
Selected results of the polymerization of acrylonitrile with bridged catalysts at 0° C.

| | | | | | | Mn | | |
|---|---|---|---|---|---|---|---|---|
| Run | Catalyst | Mon./Cat. | V [mL] | t [min] | Y [%] | [kg/mol] | PDI | TOF [h⁻¹] |
| 1 | AlMe₃ + PEt₃ | 4000 | 7.5 | 30 | 37.5 | 28 | 2 | 3000 |
| 2 | (Me)₂AlCH₂P(Me)₂ | 4000 | 7.5 | 15 | 95 | 30 | 2.4 | 15200 |

[a] Yields determined by ¹H-NMR spectroscopy of sample aliquots and of the isolated polymers determined by using gravimetric methods.
[B] Mₙ and PDI determined using multi angle laser light scattering (MALLS) detection methods.

TABLE 2
Selected results of the polymerization of vinylphosphonates and vinylpyridines with bridged catalysts at rt in THF.

| | | | [Monomer]/ | Volume | t | Yield^{[a]} | Mₙ × 10^{4[B]} | | |
|---|---|---|---|---|---|---|---|---|---|
| Run | Monomer | Lewis pair catalyst | [Cat] | [mL] | [min] | [%] | [g/mol] | PDI^{[B]} | TOF |
| 3 | DEVP | (Me)₂AlCH₂P(Me)₂ | 350 | 2.5 | 20 | 85 | 22.7 | 1.03 | 892 |
| 4 | DEVP | Al(Me)₃ + P(Me)₃ | 350 | 2.5 | 20 | 0 | — | — | 0 |
| 5 | DIVP | (Me)₂AlCH₂P(Me)₂ | 100 | 2 | 60 | 100 | 35.7 | 1.05 | 100 |
| 6 | 4-VP | (Me)₂AlCH₂P(tBu)₂ | 200 | 1 | 15 | 100 | 14.2 | 1.75 | 800 |
| 7 | DIVP | Al(Me)₃ + P(Me)₃ | 100 | 2 | 60 | 0 | — | — | 0 |
| 8 | 4-VP | (Al(Me)₃ + P(Me)₃ | 100 | 2 | 60 | 28 | — | — | 28 |

^{[a]}Yields determined by ¹H-NMR spectroscopy of sample aliquots and of the isolated polymers determined by using gravimetric methods.
^{[B]}Mₙ and PDI determined using multi angle laser light scattering (MALLS) detection methods.

### Example 1

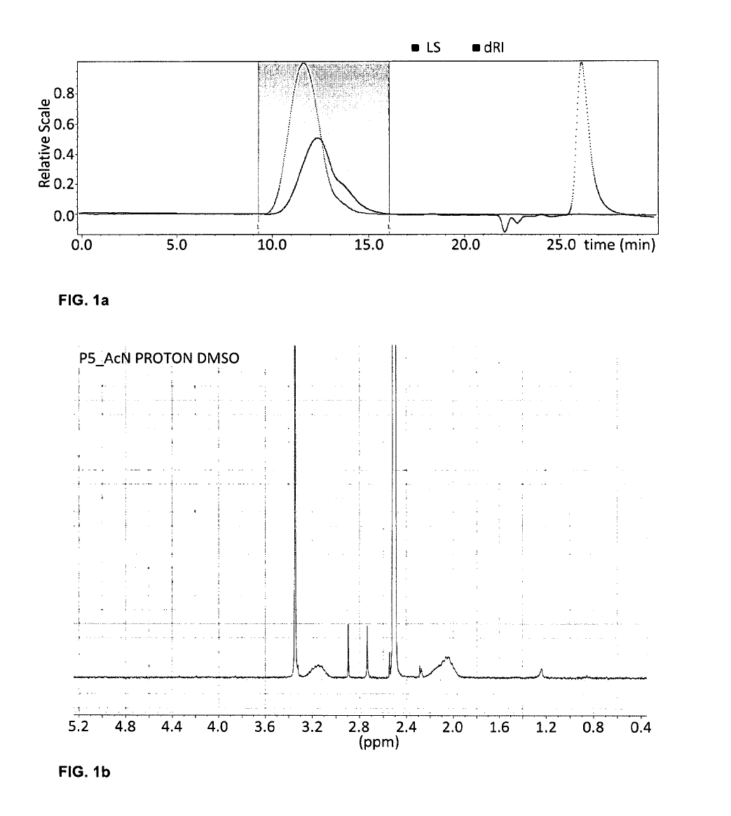

Polyacrylonitrile was produced using a catalyst system of the present invention. The reaction was performed in oven-dried glass reactor (Me)₂AlCH₂P(Me)₂ (302 μL, 12.5 mmol/L solution in toluene) was added and cooled to 0° C. Acrylonitrile (500 μL, 3.77 mmol, 400 mg, 2,000 equivalents) was added and the mixture was stirred for 15 min at 0° C. The reaction was stopped by adding a mixture of DMF-MeOH—HCl (100:10:1). A sample was taken and an ¹H-NMR was recorded. Thereafter, the polymer was precipitated in 40 mL MeOH. Centrifugation, washing a few times with each 10 mL MeOH, centrifugation and drying at 40° C. (12 h) in high vacuum yielded 169 mg (42%) polyacrylonitrile. The analytical data are shown in FIG. 1a and 1b.

### Example 2 (For Comparison)

Polyacrylonitrile was produced using a catalyst—AlCl₃—as known in the prior art. The reaction was performed in oven-dried glass reactor AlCl₃ (302 μL, 12.5 mmol/L suspension in toluene) was added and cooled to 0° C. Acrylonitrile (500 μL, 3.77 mmol, 400 mg, 2,000 equivalents) and thereafter tricyclohexylphosphine (PEt₃) (151 μL, 25.0 mmol/L solution in toluene, 1 equivalents) were added and the mixture was stirred for 15 min at 0° C. The reaction was stopped by adding a mixture of DMF-MeOH—HCl (100:10:1). A sample was taken and an ¹H-NMR was recorded. The reaction yielded no polymer.

### Example 3

Poly(diethylvinylphosphonate) was produced using a catalyst system of the present invention. The reaction was performed in oven-dried glass reactor (Me)₂AlCH₂P(iProp)₂ (302 μL, 12.5 mmol/L solution in toluene) was added and cooled to 0° C. Diethylvinylphosphonate (500 μL, 3.77 mmol, 400 mg, 2,000 equivalents) was added and the mixture was stirred for 15 min at rt. The reaction was stopped by adding a mixture of MeOH-HCl (10:1, 0.5 mL). A sample was taken and an ¹H-NMR was recorded. Thereafter, the polymer was precipitated in 40 mL pentane. Centrifugation, washing a few times with each 10 mL pentane, centrifugation and drying at 40° C. (12 h) in high vacuum yielded 189 mg (47%) polyacrylonitrile. The analytical data are shown in FIGS. 2a and 2b.

### Example 4 (For Comparison)

Poly(diethylvinylphosphonate) was produced using a catalyst—AlCl₃—as known in the prior art. The reaction was performed in oven-dried glass reactor AlCl₃ (302 μL, 12.5 mmol/L suspension in toluene) was added and cooled to 0° C. diethylvinylphosphonate (500 μL, 3.77 mmol, 400 mg, 2,000 equivalents) and thereafter tricyclohexylphosphine (PEt₃) (151 μL, 25.0 mmol/L solution in toluene, 1 equivalent) were added and the mixture was stirred for 15 min at 0° C. The reaction was stopped by adding a mixture of DMF-MeOH—HCl (100:10:1). A sample was taken and an ¹H-NMR was recorded. The reaction yielded no polymer.

### Example 5

Poly(diisopropylvinylphosphonate) was produced using a catalyst system of the present invention. The reaction was performed in oven-dried glass reactor (Me)₂AlCH₂P(Me)₂ (302 μL, 12.5 mmol/L solution in toluene) was added and cooled to 0° C. diisopropylvinylphosphonate (500 μL, 3.77 mmol, 400 mg, 2,000 equivalents) and the mixture was stirred for 15 min at 0° C. The reaction was stopped by adding a mixture of

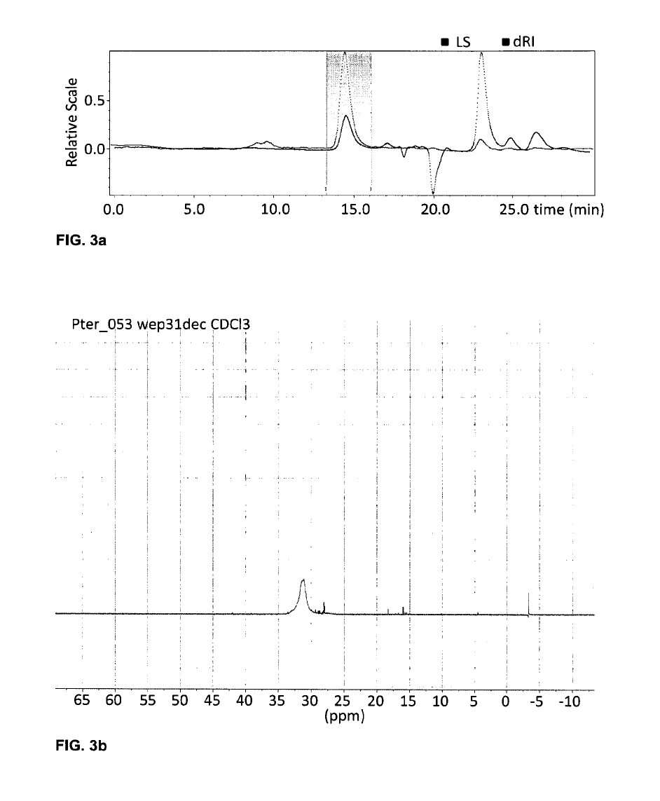

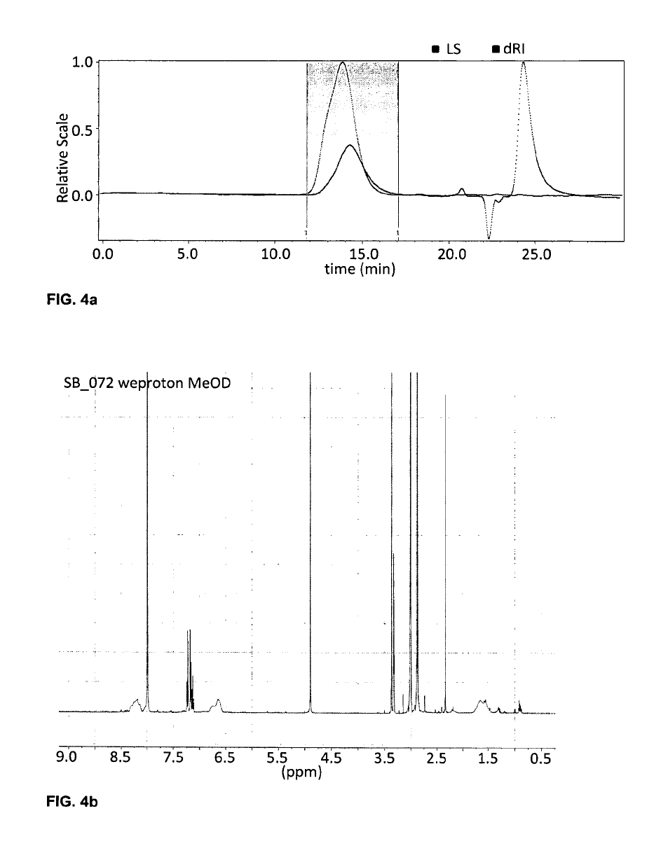

DMF-MeOH—HCl (100:10:1). A sample was taken and an ¹H-NMR was recorded. Thereafter, the polymer was precipitated in 40 mL MeOH. Centrifugation, washing a few times with each 10 mL MeOH, centrifugation and drying at 40° C. (12 h) in high vacuum yielded 149 mg (37%) polyacrylonitrile. The analytical data are shown in FIGS. 3a and 3b.

### Example 6 (For Comparison)

Poly(4-vinylpyridine) was produced using a catalyst system of the present invention. The reaction was performed in oven-dried glass reactor (Me)₂AlCH₂P(tBu)₂ (302 μL, 12.5 mmol/L suspension in toluene) was added and cooled to 0° C. diethylvinylphosphonate (500 μL, 3.77 mmol, 400 mg, 2,000 equivalents') was added and the mixture was stirred for 15 min at 0° C. The reaction was stopped by adding a mixture of DMF-MeOH—HCl (100:10:1). A sample was taken and an ¹H-NMR was recorded. The reaction yielded no polymer.

### Example 7

A polymer was produced using a catalyst/initiator of the present invention. The monomer was dimethylacrylamide. The catalyst was (iBu)₂AlCH₂PMe₂.

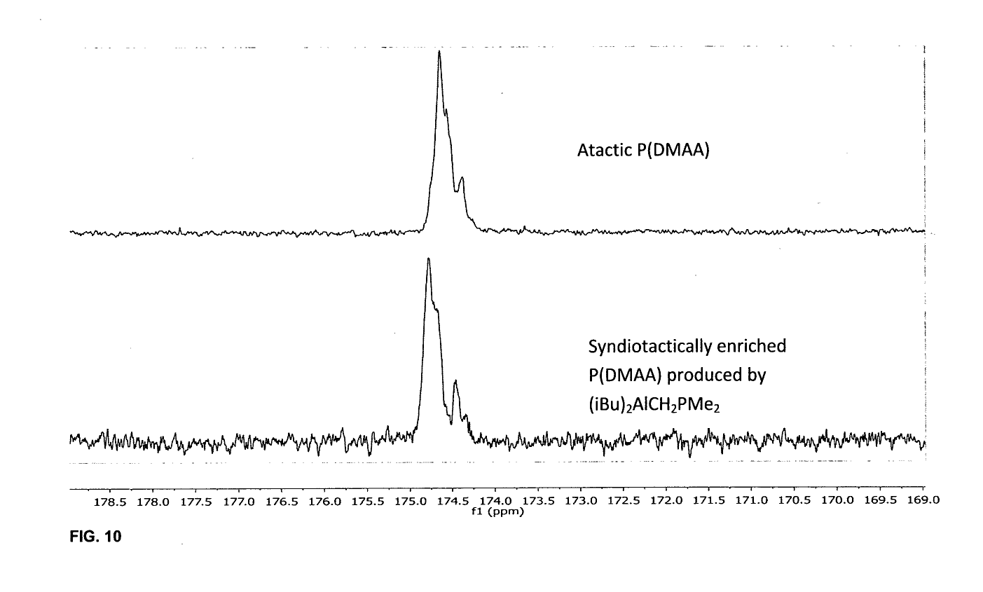

A polymer was obtained having more than 82% syndiotacticity. An NMR spectrum (FIG. 10) shows the high percentage of syndiotactic units.

### Example 8

Some experiments were made with (dimethyl(pyridin-2-yl)aluminum or dimethyl((6-methylpyridin-2-yl)methyl)aluminum) as catalyst and initiator and three different types of monomers: diethylvinylphoshonate, diisopropylvinylphosphonate, and methylacrylate. Catalyst and monomer in each run were reacted at a monomer/catalyst ratio of 100, at room temperature to yield different polymers. UV/Vis spectra (emission) in. FIGS. 5-8 show different PL maxima for different polymers in the visible range. Thus, the polymers have different photo luminescence colors depending on which monomer and which catalyst and initiator has been used.

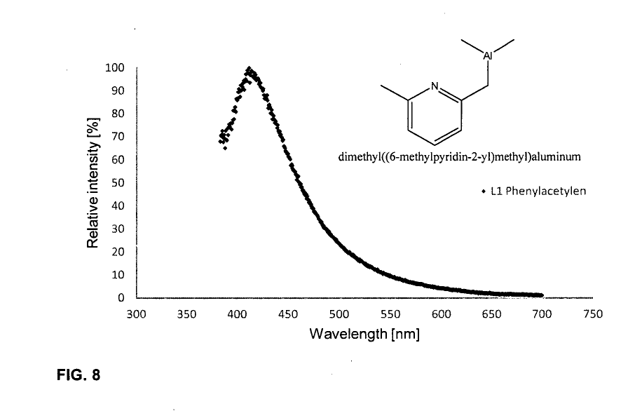

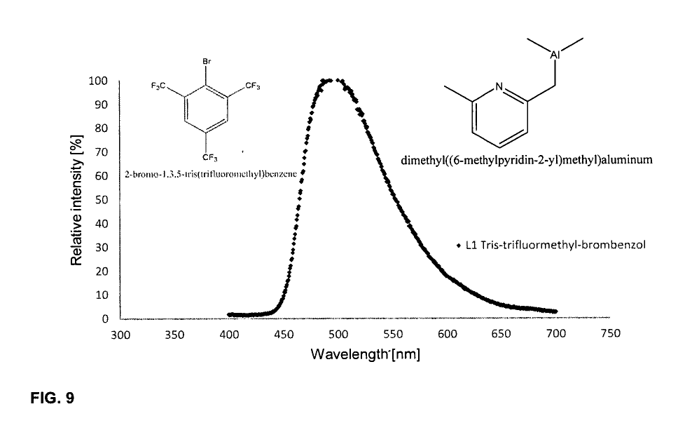

In addition, dimethyl((6-methylpyridin-2-yl)methyl)aluminum and a single molecule (phenylacetylene or 2-bromo-1,3,5-tris(trifluoromethyl)benzene) have been converted in a 1:1 stochiometry. The conversion yields photo luminescent molecules in different colors (see FIGS. 8-9).

### Example 9

In order to investigate the influence of the monomer on the photo luminescence of the polymer, the catalyst and initiator compound dimethyl(pyridin-2-yl)aluminum has been used for the polymerization of dimethylacrylamide (DMAA), diethylvinylphoshonate (DEVP) and diisopropylmethacrylamide (DiPMA) under the same reaction conditions. The UV/Vis spectra in FIG. 10 clearly show that different monomers lead to different photo luminescent polymers. Therefore, photo luminescent characteristics, such as the color of the polymers, can be altered by the variation of the monomer.

### Example 10

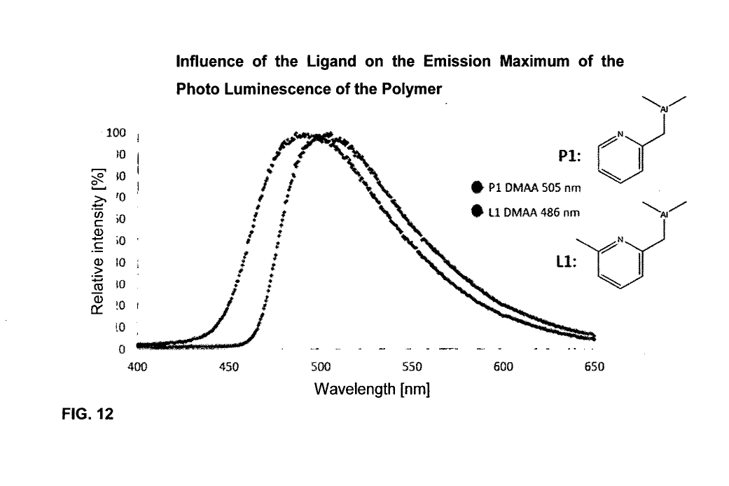

In order to investigate the influence of the ligand, which is the N-hetercyclic initiator part in this case, two different catalyst and initiator compounds (P1: dimethyl(pyridin-2-yl)aluminum or L1: dimethyl((6-methylpyridin-2-yl)methyl)aluminum) have been used to polymerize dimethylacrylamide (DMAA) under the same reaction conditions. The UV/Vis spectra (emission) of FIG. 12 show different PL maxima for the polymers resulting from the polymerization by different catalysts. Therefore, the type of catalyst and initiator compound, especially the N-heterocyclic ligand has an influence on the PL maximum. Thus, the photo luminescence properties (i.e. luminescence color) of the polymer can be altered by variation of the initiator compound.

### Example 11

Photoluminescent polymers have gathered an indisputable scientific attention during the past decades due to their broad applicability in various fields. Novel emerging applications apply these ‘smart materials’ as chemosensors, bioimaging agents and drug carriers among others. These materials in the prior art are obtained by synthesis based on radical techniques with their inherited disadvantages. The catalytic strategies of the present invention combine the advantages of controlled radical polymerizations such as a living polymerization character with rapid reaction rates and a high precision of the macromolecular parameters. These characteristics are essential for a precise and efficient synthesis of modern high performance polymers.

The present process is based on a Al(III)-mediated group transfer polymerization of Michael-type monomers. End group analysis of short chained oligomers as well as DFT calculations evidence that the polymerization occurs via a group transfer mechanism, wherein the initiation proceeds via a nucleophilic transfer of a ligand to a coordinated monomer. Hence, this method offers the possibility to synthesize Michael-type polymers containing functional groups at the polymer chain end.

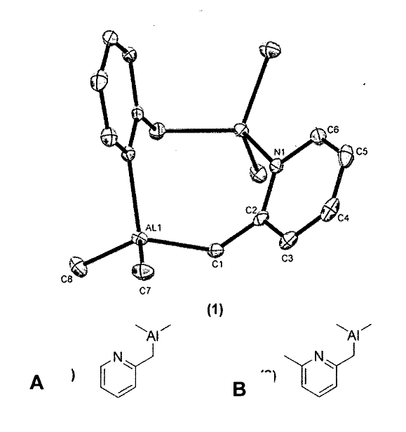

In order to further elucidate this transfer process new Al(III)-based complexes with pyridine based donor moieties were used (FIG. 13, compounds A and B). Both compounds are active catalysts for the polymerization of Michael-type monomers.

Compound A crystallizes as a dimer forming an eight membered ring. The length of the Al—N (2.03 Å) bond is typical for a coordinative aluminum nitrogen bond. It's solid state structure is depicted in FIG. 13.

Polymerization of two structurally and electronically diverse Michael monomers, namely to diethylvinylphosphonate (DEVP) and N,N-dimethylacrylamide (DMAA) has been carried out and the results are shown below.

Surprisingly, the synthesized polymers have photoluminescent properties. Since no PL can be observed during the polymerization reaction, it is assumed that the responsible structure is formed only after the termination of the reaction with methanol. The emission spectra as well as the PL under UV irradiation (365 nm) of THF solutions of two exemplary polymers produced with A are represented in FIG. 12. The electronic properties of the applied monomer appear to have a crucial influence on the wavelength of the emitted light. The emission maxima (λ_{E}) of P(DMAA) and P(DEVP) solutions differ by more than 70 nm.

Since the applied catalysts do not feature photoluminescent properties it is assumed that they undergo a reaction with the monomer to form a conjugated system, capable of emitting light.

The applied catalysts A and B have different reactivity, despite their structural similarity. While the polymerization of DEVP with A at 0° C. produces photoluminescent P(DEVP) (λ_{E}=431 nm), no PL could be observed if B is used (Table 3, exp. 1-2). Furthermore, the use of B results in diminished initiator efficiencies compared to A. Increasing temperatures have a negative effect on both the initiator efficiency and the dispersity of the produced polymers of A (Table 3, exp. 3). On the other hand a temperature rise has a positive effect on the performance of B (Table 3, exp. 4). Both A and B produce photoluminescent P(DMAA) in high yields (Table 3, exp. 5-8). In contrast to the polymerization of DEVP, a variation of the temperature has no adverse effect on the polymerization of DMAA (Table 3, exp. 7-8). Again, the initiator efficiencies of A are higher than those of B.

The emission maxima of synthesized P(DMAA) samples differ by 20 nm depending on whether A or B was applied for the polymerization (Table 3, exp. 5-8). Therefore, both the monomer and the ligands of the applied catalysts have an essential influence on the PL of the produced polymers. Additionally, the nature of the ligand has a crucial influence on the quantum yields of the polymeric products (Φ_{F}=No. of emitted photons/No. of absorbed photons). P(DMAA) Produced with A has a remarkably higher quantum yield than the samples produced with B as catalyst. These values are comparable to commercially available fluorescence markers and exceed those of conventional dye doped polymers.

TABLE 3
Polymerization of DEVP and DMAA^{[a]}

| | | A T | | | Y | | λ_{E}^{[e]} | Φ_{F}^{[f]} |
|---|---|---|---|---|---|---|---|---|
| Exp. | Mon. | [° C.] | Mₙ^{[b]} | Ð | [%]^{[c]} | I^{[d]} | [nm] | [%] |
| 1 | DEVP | 0 | 32.7 | 1.25 | 100 | 100 | 431 | n.d. |
| 2 | DEVP | 0 | 291 | 1.57 | 97 | 11 | n.o. | — |
| 3 | DEVP | rt | 43.8 | 1.73 | 100 | 77 | 431 | n.d. |
| 4 | DEVP | rt | 91.2 | 1.27 | 100 | 36 | n.o. | — |
| 5 | DMAA | 0 | 34.3 | 1.42 | 100 | 58 | 505 | 95 |
| 6 | DMAA | 0 | 101 | 1.75 | 77 | 15 | 486 | 44 |
| 7 | DMAA | rt | 32.5 | 1.36 | 100 | 61 | 505 | 96 |
| 8 | DMAA | rt | 131 | 1.32 | 90 | 14 | 486 | 44 |

^{[a]}solvent: THF, total solvent volume 1 mL (Exp. 1-4), 3 mL (Exp. 5-8), Mon./LA = 200, reaction time = 10 min,
^{[b]}determined by GPC coupled with multi angle laser light scattering (MALS) in H2O/THF (9 g/L tetrabutylammonium bromide) at 40° C., reported in 103 g/mol,
^{[c]}yield measured gravimetically and by 1H NMR spectroscopy,
^{[d]}Initiator efficiency (Mn(theo)/Mn),
^{[e]}photoluminescence emission wavelength
^{[f]}ΦF = No. of emitted photons/No. of absorbed photons.

In conclusion a new route towards photoluminescent macromolecules was presented. Two Al(III)-based group transfer polymerization catalysts were applied in the polymerization of DEVP and DMAA leading to polymeric material with high molecular weights and narrow dispersities. The synthesized polymers exhibit a very strong photoluminescence with remarkably high quantum yields. It could be shown, that the wavelength of this photoluminescence can be influenced by the monomer as well as the structure of the catalyst ligands.

1. A bridged catalyst and initiator compound for precision polymerization of Michael-type monomers, represented by the following structures: 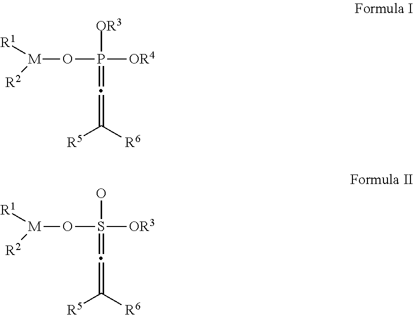
wherein M is Al, B, Ga, or In;
each R¹ and R² is independently Cl, F, I, Br, or linear, branched or cyclic alkyl, heterocycloalkyl, linear, branched or cyclic alkenyl, heterocycloalkenyl, linear, branched, or cyclic alkenyl, linear, branched, or cyclic alkinyl, heterocycloalkinyl, linear, branched, or cyclic alkoxy, aryl, heteroaryl, aryloxy, silyl, metallocenyl, nitro, nitroso, hydroxy, or carboxyl, wherein each alkyl, alkenyl, alkinyl or alkoxy independently has up to 12 carbon atoms, wherein each aryl or heteroaryl independently has 5 to 10 ring atoms, wherein any hetero group has at least one hetero atom selected from O, S or N, wherein each alkyl, alkenyl, alkinyl or alkoxy, heterocycloalkyl, heterocycloalkenyl, heterocycloalkinyl, aryl, heteroaryl, aryloxy group is optionally substituted by 1 up to the highest possible number of halogen atoms;
each R³ and R⁴ is independently linear or branched alkyl with a maximum carbon atom number of 4; and
R⁵ and R⁶ are independently hydrogen or defined as R¹ and R².

2. The bridged catalyst and initiator for precision polymerization according to claim 1, wherein the compound is selected from the group consisting of:

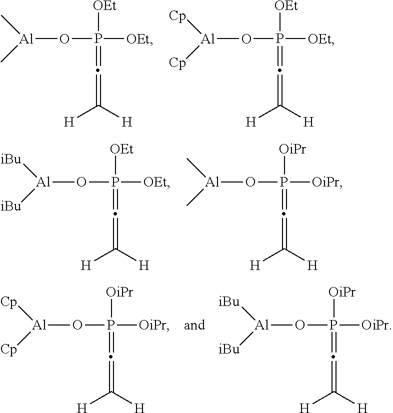

3. A process for precision polymerization of Michael-type monomers comprising:
a) contacting an α-acidic Michael-type monomer, optionally dissolved in an organic solvent, with a bridged precatalyst system comprising a Lewis acid and a Lewis base, whereby a bridged initiator and catalyst is formed, and
b) continuing the polymerization reaction to form a polymer by reaction with at least one type of an α-acidic or non-α-acidic Michael-type monomer;
wherein the bridged precatalyst comprises a Lewis acid part [R¹R²M]⁺, and a Lewis base part [Z¹PZ₂]⁻ or [Z¹SZ]⁻, covalently linked via Z¹;
wherein in the Lewis acid part [R¹R²M]⁺ M is Al, Ga, or In; each R¹ and R² is independently Cl, F, I, Br or linear, branched or cyclic alkyl, heterocycloalkyl, linear, branched or cyclic alkenyl, heterocycloalkenyl, linear, branched, or cyclic alkinyl, heterocycloalkinyl, linear, branched, or cyclic alkoxy, aryl, heteroaryl, aryloxy, silyl, metallocenyl, nitro, nitroso, hydroxy, or carboxyl, wherein each alkyl, alkenyl, alkinyl, or alkoxy independently has up to 12 carbon atoms, wherein each aryl or heteroaryl independently has 5 to 10 ring atoms, wherein any hetero group has at least one hetero atom selected from the group consisting of O, S and N, wherein each alkyl, alkenyl, alkinyl or alkoxy, heterocycloalkyl, heterocycloalkenyl, heterocycloalkinyl, aryl, heteroaryl, aryloxy group is optionally substituted by 1 up to the highest possible number of halogen atoms and
wherein in the Lewis base part [Z¹PZ₂]⁻ or [Z¹SZ]⁻ each Z independently is a linear, branched, or cyclic alkyl, alkenyl, or alkinyl group, or heteroalkyl, heteroalkenyl, or heteroalkinyl, group, having up to 12 carbon atoms; or a donor substituted aryl or heteroaryl group having 5 to 10 ring atoms; wherein any hetero group comprises at least one hetero atom selected from the group consisting of O, S, and N and
wherein Z¹⁻ is —C(R¹⁰R¹¹)—, —S—, —O—, or —N(R¹²)—, wherein R¹⁰, R¹¹, R¹², independently are hydrogen or linear or branched C₁-C₅-alkyl.

4. The process according to claim 3, wherein the α-acidic Michael-type monomer of step a) is independently selected from the group consisting of vinylphosphonates, in particular dicthylvinylphosphonatc, or diisopropylvinylphosphonatc, vinylsulfonates, acrylates, acrylonitrile, and vinylpyridines and/or wherein the at least one Michael-type monomer of step b) is independently selected from the group consisting of vinylphosphonates, vinylsulfonates, substituted or unsubstituted acrylates and methacrylates, substituted or unsubstituted acrylamides, acrylonitrile, or vinylpyridines, vinyl ketones, acrolein, and acrolein derivates.

5. A polymer produced by the process of claim 3.

6. The polymer according to claim 5, wherein the polymer is a polymer or copolymer of one or more of Michael monomers selected from the group consisting of vinylphosphonate, vinylsulfonate, substituted or unsubstituted acrylate and methacrylate, substituted or unsubstituted acrylamide, acrylonitrile, vinylpyridine, vinyl ketone, acrolein, and an acrolein derivate.

7. A precatalytic bridged complex having formula R¹R²MZ¹PZ₂ or R¹R²MZ¹SZ, wherein a Lewis acid part R¹R²M and a Lewis base part, PZ₂ or SZ, are covalently linked via a bridge Z¹, wherein M is Al, Ga, or In; each R¹ and R² is independently Cl, F, I, Br or linear, branched or cyclic alkyl, heterocycloalkyl, linear, branched or cyclic alkenyl, heterocycloalkenyl, linear, branched, or cyclic alkinyl, heterocycloalkinyl, linear, branched, or cyclic alkoxy, aryl, heteroaryl, aryloxy, silyl, metallocenyl, nitro, nitroso, hydroxy, or carboxyl, wherein each alkyl, alkenyl, or alkenyl group independently has up to 12 carbon atoms, wherein each aryl or heteroaryl independently has 5 to 10 ring atoms, wherein any hetero group has at least one hetero atom selected from the group consisting of O, S and N, wherein each alkyl, alkenyl, alkinyl or alkoxy, heterocycloalkyl, heterocycloalkenyl, heterocycloalkinyl, aryl, heteroaryl, aryloxy group is optionally substituted by 1 up to the highest possible number of halogen atoms and
wherein each Z independently is a linear, branched, or cyclic alkyl, alkenyl, or alkinyl group, or heteroalkyl, heteroalkenyl, or heteroalkinyl, group, having up to 12 carbon atoms; or a donor substituted aryl or heteroaryl group having 5 to 10 ring atoms, wherein any hetero group comprises at least one hetero atom selected from the group consisting of O, S and N and wherein Z¹⁻ is —C(R¹⁰R¹¹)—, —S—, —O—, or —N(R¹²)—, wherein R¹⁰, R¹¹, R¹², independently are hydrogen or linear or branched C₁-C₅-alkyl;
with the proviso that the compound is not (dimethyl phosphinomethyl)dimethyl aluminum.

8. A system for precision polymerization, comprising
a) an α-acidic Michael-type monomer,
b) a precatalyst having formula R¹R²MZ¹PZ2 or R¹R²MZ¹SZ comprising a Lewis acid part [R¹R²M]⁺, as catalyst, and a Lewis base part [Z¹PZ₂]⁻ or [Z¹SZ]⁻ covalently combined in one molecule,
c) optionally an organic solvent,
wherein components a) and b) can form an active initiator and catalyst complex, wherein a Lewis acid part R¹R²M and a Lewis base part, PZ₂ or SZ, are covalently linked via a bridge Z¹, wherein M is Al, Ga, or In; each R¹ and R² is independently Cl, F, I, Br or linear, branched or cyclic alkyl, heterocycloalkyl, linear, branched or cyclic alkenyl, heterocycloalkenyl, linear, branched, or cyclic alkinyl, heterocycloalkinyl, linear, branched, or cyclic alkoxy, aryl, heteroaryl, aryloxy, silyl, metallocenyl, nitro, nitroso, hydroxy, or carboxyl, wherein each alkyl, alkenyl, alkinyl, or alkoxygroup independently has up to 12 carbon atoms, wherein each aryl independently has 5 to 10 ring atoms, wherein any hetero group has at least one hetero atom selected from the group consisting of O, S and N, wherein each alkyl, alkenyl, alkenyl or alkoxy, heterocycloalkyl, heterocycloalkenyl, heterocycloalkinyl, aryl, heteroaryl, aryloxy group is optionally substituted by 1 up to the highest possible number of halogen atoms and wherein each Z independently is a linear, branched, or cyclic alkyl, alkenyl, or alkinyl group, or heteroalkyl, heteroalkenyl, or heteroalkinyl, group, having up to 12 carbon atoms; or a donor substituted aryl or heteroaryl group having 5 to 10 ring atoms, wherein any hetero group comprises at least one hetero atom selected from the group consisting of O, S and N and wherein Z¹⁻ is —C(R¹⁰R¹¹)—, —S—, —O—, or —N(R¹²)—, wherein R¹⁰, R¹¹, R¹², independently are hydrogen or linear or branched C₁-C₅-alkyl.

9. A process for preparing a bridged initiator and catalyst of formula I or II of claim 1 comprising contacting an α-acidic Michael-type monomer, optionally dissolved in an organic solvent, with a precatalyst, having formula R¹R²MZ¹PZ₂ or R¹R²MZ¹SZ in a molar ratio of precatalyst to monomer of 1:1 to 2:1, whereby a bridged initiator and catalyst is formed, wherein R¹, R², M, Z¹, Z are as defined in claim 8, wherein optionally the α-acidic Michael-type monomer is selected from the group consisting of vinylphosphonates, vinylsulfonates, substituted or unsubstituted acrylates and methacrylates, substituted or unsubstituted acrylamides, acrylonitrile, vinylpyridines, vinyl ketones, acrolein, and acrolein derivates.

10. A catalyst and initiator compound for the polymerization of Michael-type monomers, comprising a structure represented by the following formula:
[R⁹]ₙM-[Z³-Q]₃₋ₙ Formula III
wherein M is Al, Ga, or In;
wherein each R⁹ is independently Cl, F, I, or Br, linear, branched or cyclic alkyl, heterocycloalkyl, linear, branched or cyclic alkenyl, heterocycloalkenyl, linear, branched, or cyclic alkinyl, heterocycloalkinyl, linear, branched, or cyclic alkoxy, aryl, heteroaryl, aryloxy, silyl, metallocenyl, nitro, nitroso, hydroxy, or carboxyl, wherein each alkyl, alkenyl, alkinyl, or alkoxy independently has up to 12 carbon atoms, wherein each aryl independently has 5 to 10 ring atoms, wherein any hetero group has at least one hetero atom selected from the group consisting of O, S and N, wherein each alkyl, alkenyl, alkinyl or alkoxy, heterocycloalkyl, heterocycloalkenyl, heterocycloalkinyl, aryl, heteroaryl, aryloxy group is optionally substituted by 1 up to the highest possible number of halogen atoms;
wherein Z³ is a single bond, —C(R¹⁰R¹¹)—, —S—, —O—, or —N(R¹²)—, wherein R¹⁰, R¹¹, R¹², independently are hydrogen or linear or branched C₁-C₅-alkyl;
wherein Q is an aromatic system comprising up to 3 aromatic rings, wherein the rings can independently be condensed or covalently linked, wherein the aromatic rings are independently 5- or 6-membered carbocyclic or heteroaromatic rings, at least one of which is a 5- or 6-membered heteroaromatic ring comprising at least one and up to 3 heteroatoms selected from the group consisting of N, O, and S, wherein optionally Q has at least one unsubstituted carbon atom in a heteroaromatic ring in a position available for binding of an electrophilic substituent which is in vicinity to the heteroatom, wherein the system additionally is optionally substituted by one or more substituents selected from the group consisting of linear or branched C₁-C-alkyl, C₁-C₅-alkoxy, amino, nitro, nitroso, cyano, halogen, C₅-C₁₀ aryl, C₅-C₁₀ heteroaryl, and C₅-C₁₀ aryloxy;
wherein n is 0, 1, or 2
with the proviso that the compound is not diethyl-[(4-methyl-pyridin-2-y)-methyl]aluminum, diethyl-(2-pyridinylmethyl)aluminum, or diethyl(2-quinolinyl-methyl)aluminum.

11. (canceled)

12. A process for polymerization of Michael-type monomers, comprising:
a) contacting a Michael-type monomer, optionally dissolved in an organic solvent, with a bridged catalyst and initiator compound, and
b) continuing the polymerization reaction to form a polymer by reaction with at least one type of Michael-type monomer;
wherein the bridged catalyst and initiator compound is [R⁹]ₙM[Cp]₃₋ₙ or [R⁹]ₙM[-[Z³-Q]₃₋ₙ,
wherein M is aluminum, gallium or indium, wherein Cp is cyclopentadienyl, tetramethyl cyclopentadienyl, or pentamethyl cyclopentadienyl:
wherein each R⁹ is independently Cl, F, I, or Br, linear, branched or cyclic alkyl, heterocycloalkyl, linear, branched, or cyclic alkenyl, heterocycloalkenyl, linear, branched, or cyclic alkinyl, heterocycloalkinyl, linear, branched, or cyclic alkoxy, aryl, heteroaryl, aryloxy, silyl, metallocenyl, nitro, nitroso, hydroxy, or carboxyl, wherein each alkyl, alkenyl, alkinyl, or alkoxy group independently has up to 12 carbon atoms, wherein each aryl independently has 5 to 10 ring atoms, wherein any hetero group has at least one hetero atom selected from the group consisting of O, S and N, wherein each alkyl, alkenyl, alkinyl or alkoxy, heterocycloalkyl, heterocycloalkenyl, heterocycloalkinyl, aryl, heteroaryl, aryloxy group can be substituted by 1 up to the highest possible number of halogen atoms;
Z³ is a single bond, —C(R¹⁰R¹¹)—, —S—, —O—, or —N(R¹²)—, wherein R¹⁰, R¹¹, R12, independently are hydrogen or linear or branched C₁-C₅-alkyl;
wherein Q is an aromatic system comprising up to 3 aromatic rings, wherein the rings can independently be condensed or covalently linked, wherein the aromatic rings are independently 5- or 6-membered carbocyclic or heteroaromatic rings, at least one of which is a 5- or 6-membered heteroaromatic ring comprising at least one and up to 3 heteroatoms selected from N or S, wherein optionally Q has at least one unsubstituted carbon atom in a heteroaromatic ring in a position available for binding of an electrophilic substituent which is in vicinity to the heteroatom, wherein the system can be is optionally substituted by one or more substituents selected from the group consisting of linear or branched C₁-C₅-alkyl, C₁-C₅-alkoxy, amino, nitro, nitroso, cyano, halogen, C₅-C₁₀ aryl, C₅-C₁₀ heteroaryl, and C₅-C₁₀ aryloxy;
wherein n is 0, 1, or 2.

13. The process of claim 12, wherein Q is a 5- or 6-membered heteroaromatic ring comprising at least one and up to 3 heteroatoms selected from the group consisting of N, O, and S.

14. A process for preparing a luminescent component, comprising:
a) contacting a Michael-type monomer or an electrophilic substrate, optionally dissolved in an organic solvent, with a bridged catalyst and initiator compound, and
b) optionally continuing the polymerization reaction with a at least one Michael-type monomer to form a polymer;
wherein the bridged catalyst and initiator compound is [R⁹ₙM[-[Z³-Q]₃₋ₙ, wherein R⁹, n, M, Z³ and Q are as defined in claim 12, with the proviso that Q has at least one unsubstituted carbon atom in a heteroaromatic ring in a position available for binding of an electrophilic substituent which is in vicinity to the heteroatom.

15. A polymer produced by the process of claim 12.

16. A luminescent polymer produced by the process of claim 12.

17. A luminescent component produced by the process of claim 14.
